(19) United States
(12) Patent Application Publication
(10) Pub. No.: US 2025/0307954 A1
(43) Pub. Date: Oct. 2, 2025

(54) SYSTEMS AND METHOD FOR A SOCIAL MEDIA RESTING PLACE

(71) Applicant: William David Murray, New York, NY (US)

(72) Inventor: William David Murray, New York, NY (US)

(21) Appl. No.: 19/097,073

(22) Filed: Apr. 1, 2025

Related U.S. Application Data
(60) Provisional application No. 63/572,363, filed on Apr. 1, 2024.

(51) Int. Cl. G06Q 50/00

(52) U.S. Cl. CPC G06Q 50/01

(57) ABSTRACT

Social media content can be retained post-humous by establishing a digital cemetery plot for a deceased individual, who when living was an account holder of a plurality of social media accounts, each provided by a different social media platform. The digital cemetery plot is provided by a resting place platform, which indexes content of the social media accounts in accordance with a plurality of different group categories, each having a group-defined relationship with the deceased individual. A family portion of content from the social media accounts is associated with a family group. A work portion of content from the social media accounts is associated with a work group. A member of the family group accessing the digital cemetery plot is presented with the family portion of content. A member of the work group accessing the digital cemetery plot is presented with the work portion of content.

### CROSS-REFERENCE TO RELATED APPLICATIONS

This application is a U.S. Non-Provisional Utility Patent Application which claims the priority benefit of U.S. Provisional Patent Application Ser. No. 63/572,363 filed on Apr. 1, 2024, the entire contents of all of which are hereby incorporated by reference in their entirety.

### FIELD OF THE EMBODIMENTS

The field of the invention and its embodiments relate to social media and more particularly to systems and method for establishing a social media resting place persistent after death of an individual who had one or more social media accounts.

### BACKGROUND OF THE EMBODIMENTS

Increasingly, social media accounts represent a living archive about our daily lives over a period of time. Many people utilize these types of accounts to retain contact with family and friends, to memorialize events, to store their photographs, and more. When people die, however, social media accounts are problematic for many reasons related to the fact that social media accounts are personal, have numerous privacy filters, and are not configured to be utilized by a proxy.

Many social media providers will not allow new content to be posted to a person's account postmortem. Many permit a unique state, sometimes referred to as memorialize, where changes cannot occur, and access is somewhat limited. Unfiltered daily interactions, which often occur in a casual even jocular manner, often are problematic when persisted over time and removed from context. Thus, a large set of normal social media posts has a potential to cast a deceased in a misleading, unfavorable light, if permitted to be persisted over time when explanations and elaborations from an original poster are not possible due to death. Moreover, social media providers run a for profit business configured to attract views and engagement; memorializing content for a digital legacy is not a high priority. Further, social media provider terms, interfaces, and specifics are subject to unilateral change over time.

Further conventionally recognized issues include concerns related to access, privacy, emotional distress, and legacy. About access, social media providers typically require proof of death and verification of your relationship to the deceased before allowing you to close or manage their account. This can be a hurdle for loved ones during an already difficult time. It can be exasperated when numerous social media accounts exist post-mortem and when passwords are largely unknown. With regard to privacy, a deceased person's social media accounts are vulnerable to hacking or identity theft. Hackers can nefariously use the accounts to spread misinformation or spam. A deceased person exasperates these problems not being able to catch or impede improper activity. Emotional distress issues exist with seeing a deceased loved one's social media profile and posts, which can be emotionally difficult for family and friends. There is also the possibility of insensitive comments or messages being posted. Moreover, exposure of not known relationships and viewpoints, no longer screen-able by the deceased, can be generally undesirable for all concerned. Regarding legacy and account-holder desires/expectations, some people may want to keep the social media account as a memorial, while others may prefer to have it deleted entirely. In between positions exist, such as providing most “public” posts while wanting all private ones deleted. It is typically impractical to determine a deceased desires regarding social media content, which may lead to more conflict among survivors than any legacy-providing benefit provided by persisting social media content after death.

Social media platforms serve as extensive digital archives, capturing users' personal experiences, interactions, and milestones. These digital footprints often hold sentimental, historical, and legal significance for individuals and their families. However, the management and preservation of social media accounts after a user's death present numerous challenges. One issue is the complexity of handling a deceased individual's social media presence. Privacy policies and terms of service agreements vary across platforms, often restricting access to accounts unless prearranged legacy management options have been selected. In many cases, family members and estate executors encounter legal and procedural obstacles when attempting to manage, transfer, or memorialize an account. Additionally, social media accounts of deceased individuals are susceptible to hacking, identity theft, and misuse. Unauthorized access to these accounts can lead to fraudulent activity, misinformation, or emotional distress for surviving loved ones. Despite the increasing prevalence of digital estate planning, existing security measures do not always provide comprehensive solutions for preventing unauthorized access while preserving the integrity of the deceased's online presence.

Conventional social media memorialization options are often dictated by platform providers, offering limited functionality and customization. Many platforms provide a basic memorialization status that restricts interactions and prevents content modifications, but these options do not always align with a user's or their family's long-term wishes. Furthermore, the lack of standardized digital estate management policies across platforms complicates efforts to ensure that digital legacies are preserved in accordance with individual preferences. Accordingly, there is a need for an improved system and method for managing, securing, and preserving social media accounts after a user's death. An effective solution should address privacy concerns, mitigate security risks, and provide customizable legacy management options that extend beyond the constraints imposed by existing social media memorialization processes.

### RELEVANT PRIOR ART

Some existing patents and/or patent publications address digital asset management, estate planning, and online memorials; however, they do not provide a comprehensive system for preserving and curating social media legacies as described herein.

US20150242814A1 allows users to specify how they would like to treat their digital assets embedded in their online and social accounts upon their death, by choosing one or a mix of numerous options for online verification and confirmation of a person's death by comparing against the online death records of all the States. A System and protocol for second level verification of the death from the next-of-kin or a person designated by the user to be passed on to the beneficiary. Contemplates social media accounts (plural).

U.S. Pat. No. 10,015,628B1 provides location services for a burial site are disclosed. An example method comprises receiving user identifying information from a mobile application installed on a mobile device, matching a user associated with the mobile application to the burial site, receiving location data from the mobile device, determining that the mobile device is within a predetermined geofence associated with a location of the burial site, and providing to the user a guidance to the location of the burial site using the mobile application. application, the location of the burial site as an avatar associated with the deceased person using Augmented Reality techniques.

U.S. Pat. No. 11,599,961B1 discloses an estate planning and beneficiary management system according to an embodiment includes a system controller which may prompt and receive from a user information which may be necessary to create an estate planning model. The system may provide for traditional assets and digital assets, such as cryptocurrency and NFTs. The system may provide for distribution of digital assets using smart contracts and blockchain wallets.

US20160344675A1 discloses an online social-media system for deceased individuals comprises a webserver for generating a web page. Users may log-on and create an account. Account holders may create specific page or pages with information.

US20220114185A1 discloses an online social media platform for creating and securing content. In an exemplary embodiment, the content may be released upon or after the death of the user.

US20150101026A1 discloses that a living person may create a memorial social network page for a deceased person; and other living users may continuously contribute content items to that memorial page on the social network.

US20160087919 discloses an automated messaging system for distributing personalized messages of a deceased user to particular recipients on particular dates.

U.S. Pat. No. 6,947,921 discloses capturing and distributing memories of a deceased individual. An electronic storage memory database is provided having controls for allowing selective entry of information into said database with respect to said selected individual. Individuals can be pre-authorization for accessing said database for viewing or entering of data into the database with respect to a deceased individual. Also, a gatekeeper can be designated for providing editorial control over entry of said data.

Other relevant prior art includes U.S. Pat. No. 11,379,619B2, US20160260187A1, US20130332563A1, WO2022093318A1, WO2019122534A1, US20140337059A1, and US20230135050.

### SUMMARY OF THE EMBODIMENTS

Systems and methods for a social media resting place may be implemented to preserve and/or manage one or more social media accounts posthumously in a controlled and/or a secure manner. The system addresses many challenges associated with digital legacy management, including, but not limited to, access and privacy restrictions, emotional distress for survivors, security vulnerabilities, and/or varying legacy preferences. Traditional account management policies often prevent loved ones from accessing or modifying a deceased user's social media presence due to stringent security measures and the absence of pre-established access credentials.

This system provides a structured approach to account preservation, ensuring that content is retained or removed based on predefined user preferences or authorized decisions by designated individuals. By mitigating the risks of hacking and unauthorized access, the system safeguards digital legacies from misuse while allowing for appropriate memorialization. Additionally, the system may incorporate one or more filtering mechanisms to curate content, reducing potential emotional distress caused by unfiltered past posts or inappropriate interactions. The system also accommodates diverse legacy preferences, enabling users to specify whether their content should be preserved, transferred, or deleted upon their passing. Through these features, the Social Media Resting Place offers an improved, customizable, and secure method for posthumous digital account management, ensuring that online presences are handled in accordance with user intentions and family considerations.

This disclosure enables a social media resting place that preserves social media accounts and/or content of deceased persons to endure in a virtual cemetery selected and controlled by an executor of the account. Similar to a family plot or plots in a traditional cemetery or mortuary, a user and/or executor is able to create a social media resting place full of content related to the deceased, which can be accessed to remember lost loved ones. Unlike traditional cemeteries, a “one to many” arrangement permits a deceased to be present in a family plot as well as other groups, such as teams, schools, companies, or religious affiliation. Information available to each group by accessing the digital plot can be limited by group. That is, family will have access to family related content. Work peers will have access to work-related content. In one embodiment, social media content accessible via the digital plot is supplemented with photos and other media, which were not on one of a user's social media account when alive. Social media content accessible via the digital plot can be curated and/or sanitized. In one embodiment, a resting place platform can copy content from a set of social media accounts of a deceased person and thereafter disable access to these accounts.

The resting place platform helps establish a digital legacy, which retains digital impressions of a loved ones life for future generations. In embodiments, the resting place platform operates as a subscription service, which can be priced by individual, family, or group. Utilizing a subscription service permits postmortem information to be retained and to remain accessible, outside the constantly changing whims of most commercial social media platforms. In embodiments, additional fees for resting place platform services can be obtained directly from affiliates, such as cemeteries wanting to avail themselves of our digital resting place platform or partnering estate law practice groups wanting to provide competition differentiating services.

In one aspect of the disclosure relates to a social media cemetery for retaining social media content post-humous. The social media cemetery includes a resting place platform having at least a computing device with a processor and a memory storing a set of computer readable instructions, which when executed by the processor cause the computing device to perform a set of actions. One action is to establish a digital cemetery plot for a deceased individual, who when living was an account holder of a plurality of social media accounts, each provided by a different social media platform. The digital cemetery plot is provided by the resting place platform, which indexes content of the social media accounts in accordance with a plurality of different group categories, each having a group-defined relationship with the deceased individual. The first portion of content from the social media accounts is associated with a first group. A second portion of content from the social media accounts is associated with a second group. The first portion and the second portion each comprise content from more than one of the social media accounts. Responsive to an access request directed to the digital cemetery plot from a first of the different computing devices, a first user requesting access is determined to be a member of the first group, which results in providing access to the first portion of content. Responsive to an access request directed to the digital cemetery plot from a second of the different computing devices, a second user requesting access is determined to be a member of the second group, which results in providing access to the second portion of content.

In another aspect, social media content can be retained post-humous by establishing a digital cemetery plot for a deceased individual, who when living was an account holder of a plurality of social media accounts, each provided by a different social media platform. The digital cemetery plot is provided by a resting place platform, which indexes content of the social media accounts in accordance with a plurality of different group categories, each having a group-defined relationship with the deceased individual. A family portion of content from the social media accounts is associated with a family group. A work portion of content from the social media accounts is associated with a work group. A member of the family group accessing the digital cemetery plot is presented with the family portion of content. A member of the work group accessing the digital cemetery plot is presented with the work portion of content.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 depicts schematic diagram of a social media resting place for managing digital content post-mortem, in accordance with embodiments of the present invention.

FIG. 2 depicts a block diagram of a resting place server application, in accordance with embodiments of the present invention.

FIG. 3 depicts a block diagram of a set of computing devices referenced in FIG. 1, in accordance with embodiments of the present invention.

FIG. 4A is a block diagram depicting a family grouping and various social media affiliations, in accordance with embodiments of the present invention.

FIG. 4B is a diagram showing a relationship between social media, tagged groups, and an individual, in accordance with embodiments of the present invention.

FIG. 4C is a diagram showing a relationship between a resting place account, a photo library, other digital content, and social media, in accordance with embodiments of the present invention.

FIG. 4D is a diagram showing a digital plot of a family resting place, in accordance with embodiments of the present invention.

FIG. 5 is an illustration of a diagram of an embodiment of the system architecture for the resting place server application of FIG. 2, in accordance with embodiments of the present invention.

FIG. 6 illustrates a user interface for a digital platform for the resting place server application of FIG. 2, where individuals can preserve and manage family legacies online, in accordance with embodiments of the present invention.

FIG. 7 illustrates a user interface for a digital platform for the resting place server application of FIG. 2, displaying the pricing plans of “The Sometery,” a digital platform configured as a “social media resting place” for preserving family legacies online, in accordance with embodiments of the present invention.

FIG. 8 is a block diagram illustrating a social media cemetery, according to some embodiments of the present disclosure.

FIG. 9 is a block diagram further illustrating the social media cemetery from FIG. 8, according to some embodiments of the present disclosure.

FIG. 10 is a block diagram further illustrating the social media cemetery from FIG. 8, according to some embodiments of the present disclosure.

FIG. 11 is a block diagram further illustrating the social media cemetery from FIG. 8, according to some embodiments of the present disclosure.

FIG. 12 is a flowchart illustrating a method for retaining social media content, according to some embodiments of the present disclosure.

FIG. 13 is a flowchart further illustrating the method for retaining social media content from FIG. 12, according to some embodiments of the present disclosure.

FIG. 14 is a flowchart illustrating a method for retaining social media content, according to some embodiments of the present disclosure.

FIG. 15 is a block diagram illustrating a system, according to some embodiments of the present disclosure.

FIG. 16 is a block diagram further illustrating the system from FIG. 15, according to some embodiments of the present disclosure.

FIG. 17 is a block diagram further illustrating the system from FIG. 15, according to some embodiments of the present disclosure.

FIG. 18 is a block diagram further illustrating the system from FIG. 15, according to some embodiments of the present disclosure.

FIG. 19 is a flowchart illustrating a method for managing digital content, according to some embodiments of the present disclosure.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person having ordinary skill in the art. Combinations of features of different embodiments are meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements), etc.

As used herein, the word “include,” and its variants, is intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

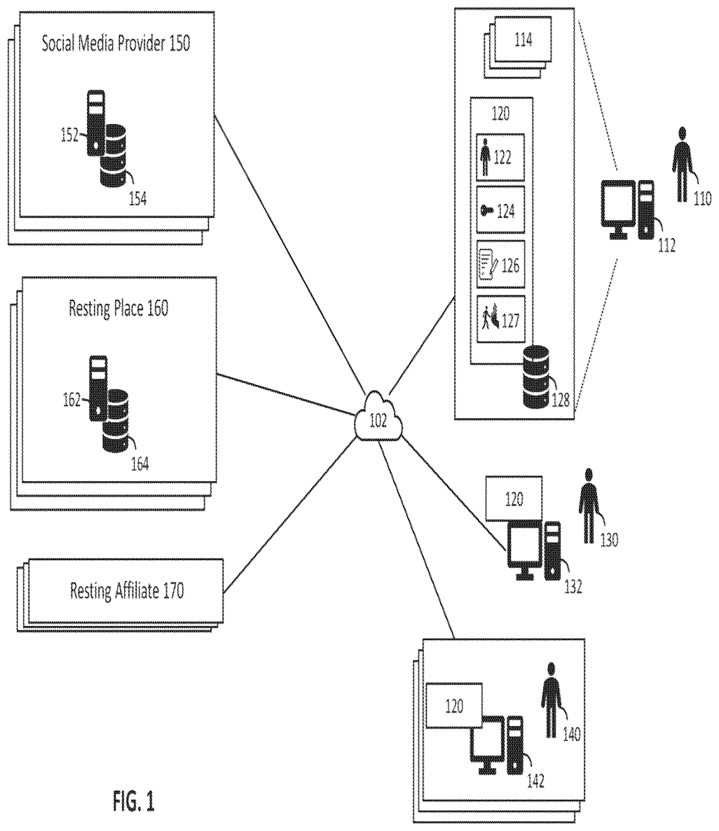

FIG. 1 shows a schematic diagram of a social media resting place for managing digital content post-mortem, in accordance with arrangements disclosed herein. A social media account user 110, who at some point dies, utilizes one or more computing devices 112 to interact with their social media accounts over a network 102. An interface or application 114 tailored for the various social media platforms run by social media providers 150 can be used for these interactions, each of which involves a social media server 152 and a social media data repository 154. User 110 may also interact with a resting place (RP) interface and application 120, which interacts over network 102 with RP platform 160, which relies on RP server 162 and RP data repository 164. It should be appreciated that in embodiments, content depicted as being within RP data repository 164 can instead be retained in one or more social media data repositories 154. That is, cost savings are achieved by minimizing storage and overhead required of maintaining social media content in RP platform's repository 164, especially when this information is already retained in an assessable manner. Despite this savings, retaining social media content in repository 164 is preferred in embodiments, as it ensures control of content as well as an ability to index and access this content intelligently and efficiently.

As noted above, The RP platform 160 is configured to manage a deceased user's digital presence by handling social media accounts, content, and personal data according to pre-established conditions. Users 110 can appoint RP Executors 122 to manage their digital assets post-death, securely storing login credentials and passwords 124 for various social media platforms 150. The platform enables the creation of an RP Will 126, allowing users to set conditions for data retention, deletion, and content visibility. It also provides customizable access 127 to the RP repository 164, granting different groups, such as family, work, or community, controlled permissions. Granular access controls allow for unions or intersections of content, ensuring that each group views only the appropriate digital assets.

In one embodiment, one or more RP executor 130 is appointed granted selective levels of control regarding the resting place platform 160, which is accessible to executor via application 120 running on their own device(s) 132. Levels of control available to RP executor 130 may be established by user 110 pre-death via an appointment feature (122). In embodiments, any action able to be taken by user 110 with the RP platform 160 pre-death can be performed instead by the executor 130. Permissions and conditions 126 restraining this ability can be established by user 110 in embodiments.

After death, RP platform 160 can be accessed by a group of interested individuals 140 via their own computing devices 142 through application 120, which accesses RP platform 160 over network 102. In embodiments, a set of resting affiliates 170 may exist that have access to at least a portion of the content of the RP platform 160. For example, a cemetery may have a Web site that is granted a level of access to RP content associated with users 110 who have died and been buried in the cemetery. In one embodiment, resting affiliates 170 may include social media accounts maintained by SM providers 150, which are owned by close relatives or an RP executor 130. Thus, some level of RP content maintained by platform 160 posthumously that would otherwise be accessible via platforms provided by social media provider(s) 150, may be made available through affiliation (170) with RP platform 160.

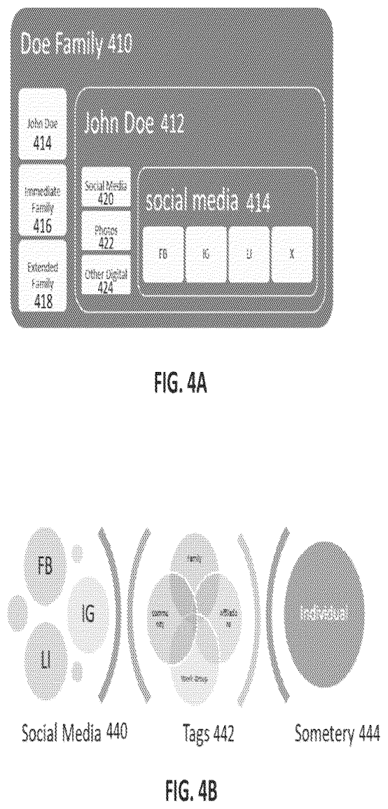

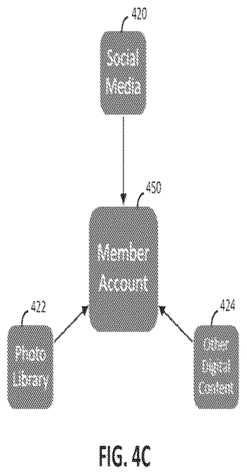

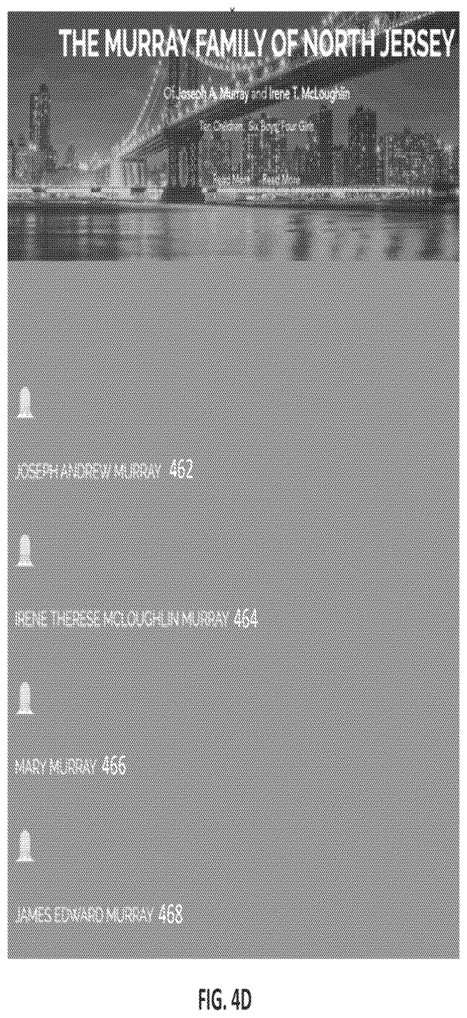

With reference to FIG. 4D a simplified view of a potential RP family plot 410 is shown. As shown, RP plots exist for Joseph 462, Irene 464, Mary 466, and James 468 Murray. Relationships and hierarchies can be shown in embodiments, such as in a genealogical view. Alternatively, plots (similar to those of a cemetery) are reserved as desired, where an expanded genealogical view can be presented, such as by hovering over one of the names 462-468 or selecting a related option.

Selection of a plot, such as icon shown in FIG. 4D can present a more detailed interface, such as that shown in FIG. 4A for John Doe. That is, from the family 410 plot, which can be shown in a user interface of application 120, a specific member, such as John Doe 414 can be selected. Additional family members that are immediate family 416 of John Doe can also be displayed, as can extended family 418. In embodiments, only deceased members who are occupying the RP plot may be shown, where others are grayed-out to be non-selectable and/or are otherwise obscured. In a different embodiment, living individuals with a reserved RP plot linked to a family plot 410 may be so, noted. Further, links to living member(s) active social media accounts can be provided in such an embodiment.

John Doe's plot 412 permits authorized individuals' access to authorized RP content (contained in RP repository 164), which includes social media 420 content, photos 422, and other digital media 424. The different social media platforms from which content was acquired can be separately indexed and displayed, as shown by social media interface 414. For example, one grouping can exist for FACEBOOK, another for INSTAGRAM, another for LINKED IN, and another for X (formerly TWITTER). There is no limit to the number of different social media platforms that are supported for the virtual plot 410. As shown, indexes for source(s) of content in repository 164 can be established and utilized for ease of access. These indexes can be overly complex, as different permissions are able to be established based on, for example, privacy rights and groupings originally established for the different social media sites. Accordingly, indexing content, even when no longer contained in a specific underlying social media platform, by the original platform is a logical grouping for content digestion. A family plot is not limited to grouping by original social media site, and in embodiments content can be aggregated across these original social media account boundaries and presented in aggregate.

To elaborate, with reference to FIG. 4B, a user 110 may have multiple social media accounts 440. These accounts can be inherently tagged 442 for different groups. For example, linked in accounts are typically associated with a work group (shown in tags 442) more than a family group 442. Some FACEBOOK accounts that user 110 participates in may be for a specific community or organization. User 110 may even run or operate an organizational account, such as an AUDIBAUM account for birds of prey. Some social media accounts 440, like those on DISCORD, are often independently run for an interested group or community. In short, an individual (user 110) desiring to establish a digital legacy and/or preserve and/or control social media 440 content post death (via RP platform 160), inherently often has an overlapping set of groups and social media accounts that relate to that individual. SOMETERY 444, a trade name referring to a social media cemetery, is configured to account for the various tags 442 and social media accounts 440 via RP platform 160.

Referring to FIG. 4C, for example, each account 450 on RP platform 160 can include a photo library 422, social media content 420, and other digital content 424.

Referencing FIG. 1, user 110 via RP application 120 may establish one or more RP executor(s) 122 having a level of control of his/her RP account once they have passed away or died. Further, security 124 information is captured and used by the resting place platform 160, which may include login credentials and passwords to the various social media providers 150 that user 110 utilizes. In one embodiment, the user 110 can establish a set of conditions that are to be applied upon his/her passing, which could be referred to as a RP will. These conditions 126 establish a level of retention desired of the various social media accounts 114, a level of content filtering, content to be exposed and/or deleted upon death, and the like. Content not available on a social media platform, such as that maintained in a personal data store 128 can be aggregated with social media account information, in embodiments.

Moreover, user 110 can establish group permissions 127 for accessing RP content, such as content that is ultimately stored in repository 164. Different grouping levels can expose different content to different groups. In one embodiment, content in the RP repository 164 is tagged and/or indexed in accordance with the guidance of user 110. Although any variety of groupings can be utilized, in one embodiment, groupings can be for family (with breakdowns for immediate and extended family, for work associates, for his/her community in general, and for other affiliations. In some embodiments, social media content that was private for a specific grouping may be available only to that group or set of individuals upon the user's (110) death. Handling rules for overlapping groupings can be established via conditions 126 and/or group-based categories, to determine whether conflicting groupings, if any, result in access to a union or intersection of approved content.

For example, a Set A of content of repository 164 may be available to all close relatives and a Set B of content may be available to brothers of user 110, and a Set C may be available to a single brother of user 110. In such a case, depending on conditions 126, access to all brothers may be restricted to the group representing a union of Set A and Set B. In another case, conditions 126 may indicate that an inner join, outer join, or intersection of content is available. Particularly sensitive or constrained information may require additional passwords to access and/or specific approval of an executer 122. For instance, user 110 may have one or more children with a genealogy different than is commonly known. A circumstance could arise, post death of user 110, where this information becomes important. For example, it may relate to a relative risk of an inheritable disease, for which information has been recorded in RP repository 164. Access to this information, however, may be restricted based on a need-to-know, as determined originally by conditions 126 established pre-death and by extended permissions able to be enabled by an appointed trustee/executor.

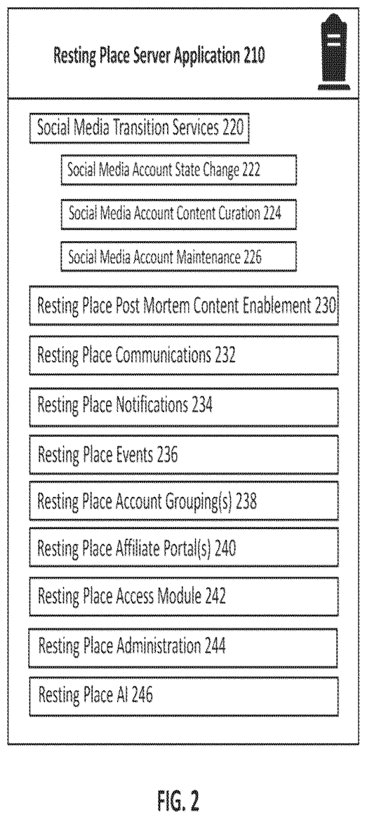

Referring to FIG. 2, the RP platform 160 can execute a set of software modules or applications, such as resting place (RP) server application 210. In one embodiment, the application 210 can include modules for social media transition services 220, RP postmortem content enablement 230, RP communications 232, RP notifications 234, RP events 236, RP account groupings 238, RP affiliate portals 240, RP access module 242, RP administration 244, and RP artificial intelligence 246.

The social media transition services 220 can be used to modify one or more social media accounts of user 110, to extract content from these accounts, to maintain these social media accounts, and the like. For example, different social media platforms have platform specific rules and guidelines that direct what is to be done with a social media account, upon a user's 110 death. Many of social media platforms, like FACEBOOK, permit and even require accounts to be memorialized or deleted. Different social media platforms have different policies and rules, which evolve and change over time. The social media transition services 220 can be constantly updated to operate consistently with these changing rules and guidelines and to minimize overhead on caregivers of applicable accounts. For example, automated reporting, automatic field completion, and the like can occur based on information contained in the RP repository 164, which is needed to satisfy required fields. Thus, in one embodiment, when multiple social media accounts require proof of death be conveyed, a death certificate and related information can be stored centrally in RP repository 164 and thereafter conveyed, VIA APIs or automatically filled forms depending on capabilities of the social media platforms, by transition services 220. In embodiments, some manual handling may be required, which can be completed by backend employees of the RP platform 160 in embodiments, such as for a fee. An effort is made to constantly update the transition services 220 to facilitate upon-death actions to be taken regarding popular social media platforms. These facilitation services ease the burden on surviving family, including RP executor 130, which are often heavily burdened with death-related overhead and emotional grief following a passing of user 110. In embodiments, the prior to death of user 110, the RP platform 110 will maintain credentials, passwords, and other needed information (entered prior to death via component 124) as well as defined conditions and decisions (via component 126) consistent with wishes of user 110. In other embodiments, an RP executor 130 will manage and/or input some of this information to RP platform 160 post death via the same components 124 and 126.

It is contemplated that partnerships with various social media providers 150 and RP platform 160 may intentionally streamline this process. That is, since RP platform 160 is a trusted source able to verify a user's passing via a death certificate, social media providers 150 may place a premium weight on reporting from RP platform 160 over general reporting from unknown actors. For example, a user 110 of RP platform 160 may provide verification and authorization information prior to death, which is able to be certified and/or confirmed, so that even when a user 110 has recently changed login information or password information, a request from RP platform can be verified and confirmed by the various social media platforms. In one contemplated embodiment, some social media platforms of providers 150 may pre-authorize access by RP platform 150, when so indicated by still living user 110, which enables actions to be taken post passing even though credentials used by user 110 for the social media providers 150 have changed in between. In one instance a machine generated RP platform 160 access code can be established, which is effective by default until or unless canceled by user 110. Partnerships and affiliations (170) between RP platform 160 and the various social media providers 150 may streamline post-death processing and permit some limited communications as directed and controlled by RP platform 160. For example, although a social media account of user 110 has been “frozen” by being memorialized, which typically prevents new postings, limited postings from RP platform 160 indicating funeral arrangements, memorials, videos of a funeral, and the like may be enabled by various ones of the providers 150, which are to be considered within the scope of transition services 220 in embodiments.

Services 220 can include a social media account state 222, social media account content curation 224, and social media account maintenance 226 components or modules. The social media account state change module 222 permits reporting, closing, and changing account states of social media accounts of user 110 from active to a different state, such as memorialized, post death. In one embodiment, the RP executor 130 is expressly authorized to trigger state changes via module 222. In one embodiment, activities of module 222 are automatically performed or facilitated by RP platform 160 upon death of user 110.

Social media account content curation module 224 acquires content from the various social media providers 150 from accounts of user 110 and places this content in RP repository 164. Content can be acquired and aggregated using AI tools which will be optional for the curator to leverage in order to find content that may not be known or easily found. The Curator will have the ability to sort, filter, include, or not include and dismiss it as “not desired, not relevant, or even incorrect. Content added to repository 164 can be tagged and indexed to ensure as little relevant information is lost as possible during this transition. This includes information related to permissions, privileges, and access limitations (specifiable by component 124). Tagging or indexing can establish different defined relationships, such as family, work, community, and other affiliation, as mentioned with reference to FIG. 4B. Lower-level indexing can also occur, such that private groups and private content, as maintained within the social media accounts, are indexed to the same subsets and groupings of people, so as to not expand the privacy of acquired content beyond that existing during a life of user 110. Filters may be placed (based on conditions from module 126) so that not all content in social media accounts is transferred to RP repository 164. Encryption, archiving, and data compression can be used in embodiments to prevent a loss of content while striking a privacy balance, such that actions of RP executor 130 may be necessary to unencrypt retained, but sensitive content maintained by RP repository 164. Once again, the Curator will have access to AI tools that may suggest index tags from the tags previously used by the Curator or from the authentication process which “learns” what the Curator is looking for. Ultimately, an association model will form from the indexing and/or tagging and the AI model will become more accurate and efficient for the Curator. The model will be leveraged to create the simulated discussion between the decedent and the viewer. Other audible affiliations to formulate the voice of the decedent will be developed in phases as the AI model matures in phases.

In one embodiment, the curation module 224 will actively delete content from social media repositories 154 consistent with wishes of user 110 and/or RP executor 130, as determined via components 124-127. Deleting content may require special actions be taken with the social media providers 150, which often maintain data through their service policies. Deleting an account can amount to placing it in an inactive state and preventing access to its content to the public. These policies, which represent a contract with user 110, however, may not be enforceable post death, so various state-specific laws and policies can apply to deleting functions of module 224. Staff of RP platform 160, therefore, may facilitate removals that are often beyond the competence or persistence of an executor 130. Sanitization of content originally maintained by social media platforms may be large to ensure memories of those passing are properly safeguarded. In another embodiment, by default the RP platform 160 points to a set of social media accounts, which maintains the content therein in repositories 154. In such a case, sanitation of data may be utilized to ensure content accessible post death is consistent with desires of executor 130 and/or as established by platform 160. Sanitation, as used herein, may restrict access to previously available content, such as to the executor 130 only, in lieu of deleting it from the respective social media provider's 150 platforms. Details of effectively maintaining access to content via the resting place platform 160 may vary based on policies established by the various social media providers 150. Regardless, content viewable by interested users 140 can be constrained as established via the resting place platform 160.

Sometimes a user 110 will desire a social media account to be maintained post death, and some social media providers 150 may permit this. Social media account maintenance module 226 facilitates the maintenance of such social media accounts. For example, a single message can be posted by RP executor 130 via module 226 that is conveyed, posted, pinned, and the like to multiple different social media accounts of providers 150. In another example, an RP executor 130 can delete and block a person across maintained social media accounts of deceased user 110 via module 226. As noted, in some embodiments, social media content will not reside in data repository 164, but the RP platform 160 will link to content maintained in repositories 154 by provider(s) 150. In such cases, instead of deleting and moving content, an effective equivalent occurs, such as through linking/redirecting and/or sanitizing data in one or more of the repositories 154.

RP postmortem content enablement module 230 can automatically provide information related to a passing of user 110 to a set of concerned individuals 140. In embodiments, this can involve sending private messages to these individuals, such as via a friends list of social media sites prior to terminating and/or transitions these sites via module 220. High level rules regarding the types of posts permitted by concerned individuals 140 to RP platform 160 are established. Filters can be automatically applied. In embodiments, RP executor moderates this content 130. In one embodiment, only content approved or originated by RP executor 130 is posted.

In addition to existing content related to eh decedent, the family will have features and functionality to create new content related to the decedent's life. The application will allow for the creation of various types of remembrance formats including an obituary, announcement, timeline of pictures and videos, written or published content, other art or talent created content. The RP executor or curator will maintain the rights to perform or delegate the authority to create these features and sections of the decedent's plot.

RP communications module 232 facilitates communications among the set of concerned individuals 140 through RP platform 150. Communications may be restricted by group and category in embodiments. For example, individuals known to be in a workgroup or on a project with user 110 may, in embodiments, utilize communications facilitated by module 232 to discover each other or complete a project, even though these individuals may not have directly communicated with each other prior to death of user 110. Diverse sets of families may send family-wide messages to each other via communications module 232 leveraging RP platform 160. In one embodiment, email lists, pre-approved for distinct categories by user 110 prior to death and/or by executor 130, can facilitate email, text, and/or autodial communications. In one contemplated embodiment, a user 110 can direct content from repository 128 to be communicated to a set of defined people post death, which is facilitated by communications module 232.

RP notification module 232 may be able to convey notifications 234 pertinent to user 110 after their death. Notifications may include, for example, notifications of a remembrance ceremony and/or a post-mortem award that user 110 is receiving. Notifications 234 can be established for diverse groups, consistent with tags 442 established for social media content.

RP Events 136 can record dates and trigger messaging (via component 232 and/or 234) regarding user 110. For example, a birth date event and/or wedding anniversary specific to user 110 can be recorded and conveyed to a set of immediate relatives. In another example, children surviving user 110 can be conveyed a message, picture, and the like of user on the birthday of that child, as established by event module 236. Event module 236 may facilitate a timed release of information, per the wishes of user 110, as established by conditions 126.

RP account groupings 238 is consistent with the tags 442. That is, different groupings of people may be granted access to different content maintained within RP repository 164. In embodiments, a grouping can represent a family plot. Unlike physical cemeteries, RP groupings 238 may permit a single individual to reside in different plots, in accordance with different established hierarchies. For example, if a user 110 founded a charity, he/she may reside in a charity specific digital cemetery plot, which is limited to that charity's biggest advocates. The same user 110 may reside in a family plot that includes his/her deceased partner, as well as a different family plot that includes his/her surviving partner. The groupings 238 of different plot's, content access, and content accessibly lists may differ for an individual having a presence in more than one grouping or digital plot.

RP affiliate portal module 240 permits access portals, hyperlinks, and the like for content in RP repository 164 to be shared with various other web sites and access points. In one embodiment, for example, a cemetery where a person is physically buried may have a digital map and/or website, which is affiliated with RP platform 150. In another embodiment, a WIKIPEDIA entry for a person can be affiliated with RP repository 164 content. In still another embodiment, a charitable foundation (started by user 110) can have a Web site that is provided content from repository 164 when events (236) are triggered. Module 240 can facilitate the linkage between content, which may be active content placed in a remote site, contained in RP platform 150 and its affiliates. Affiliated content may be limited or constrained consistent with component 126.

RP administration module 244 handles administrative tasks related to the RP platform 150. For example, some activities in RP platform 150 can be subscription for a fee, where account balances, payments, and the like are able to be managed through administration module 244. Passwords, access credentials, and the like can be modified via module 244. In embodiments, module 244 can provide information concerning a frequency and/or identity of those accessing RP content 164 for a particular user 110, which may be useful for RP executor 130. In embodiments, prepaid accounts can be established via module 244 by user 110 to maintain subscription services for RP platform 150, if any, for durations post death.

RP AI 246 can leverage artificial intelligence to enhance features of the RP platform 150. In one embodiment, RP AI 246 can assist with curation 222, and group 238 determination, based on content analyzed in RP repository 164. In other embodiments, RP AI 246 can facilitate communications (232) to discover and effectuate a communication. Embodiments are contemplated where RP AI 246 can establish a simulated experience of user 110 post death, so that a loved one having a tough time in a grieving process is able to have simulated interactions consistent with the wishes of user 110 and/or approval of RP executor 130.

### Systems, Devices and Operating Systems

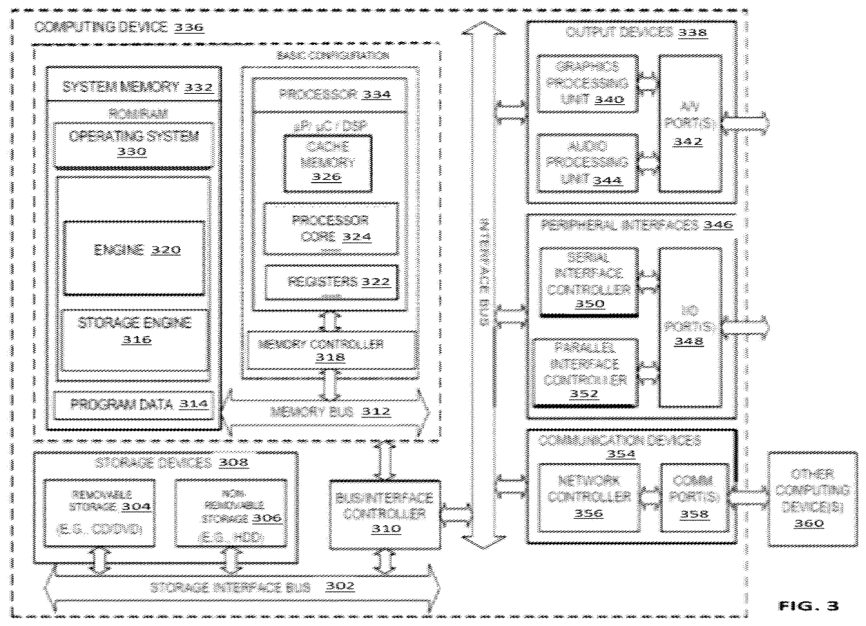

A basic configuration of a computing device 336 (such as the computing device 112, 132, 142, 152, and 162 of FIG. 1) is illustrated in FIG. 3 by those components within the inner dashed line. In the basic configuration of the computing device 336, the computing device 336 includes a processor 334 and a system memory 332. The terms “processor” and “central processing unit” or “CPU” are used interchangeably herein. In some examples, the computing device 336 may include one or more processors and the system memory 332. A memory bus 312 is used for communicating between the one or more processors 334 and the system memory 332.

Depending on the desired configuration, the processor 334 may be of any type, including, but not limited to, a microprocessor (μP), a microcontroller (μC), and a digital signal processor (DSP), or any combination thereof. In examples, the microprocessor may be AMD's ATHLON, DURON and/or OPTERON; ARM's application, embedded and secure processors; IBM and/or MOTOROLA's DRAGONBALL and POWERPC; IBM's and SONY's Cell processor; INTEL'S CELERON, CORE (2) DUO, ITANIUM, PENTIUM, XEON, and/or XSCALE; and/or the like processor(s).

Further, the processor 334 may include one more levels of caching, such as a level cache memory 326, a processor core 324, and registers 322, among other examples. The processor core 324 may include an arithmetic logic unit (ALU), a floating point unit (FPU), and/or a digital signal processing core (DSP Core), or any combination thereof. A memory controller 318 may be used with the processor 334, or, in some implementations, the memory controller 318 may be an internal part of the memory controller 318.

Depending on the desired configuration, the system memory 332 may be of any type, including, but not limited to, volatile memory (such as RAM), and/or non-volatile memory (such as ROM, flash memory, etc.), or any combination thereof. The system memory 332 includes an operating system 330, one or more engines, such as an engine 320, and program data 314. In some embodiments, the engine 320 may be an application, a software program, a service, or a software platform, as described infra. The system memory 332 may also include a storage engine 316 that may store any information of data disclosed herein.

The operating system 330 may be a highly fault tolerant, scalable, and secure system such as: APPLE MACINTOSH OS X (Server); AT&T PLAN 9; BE OS; UNIX and UNIX-like system distributions (such as AT&T's UNIX; BERKLEY SOFTWARE DISTRIBUTION (BSD) variations such as FREEBSD, NETBSD, OPENBSD, and/or the like; Linux distributions such as RED HAT, UBUNTU, and/or the like); and/or the like operating systems. However, more limited and/or less secure operating systems also may be employed such as APPLE MACINTOSH OS, IBM OS/2, MICROSOFT DOS, MICROSOFT WINDOWS 2000/2003/3.1/95/98/CE/MILLENNIUM/NT/VISTA/XP (Server), PALM OS, and/or the like. The operating system 330 may be one specifically optimized to be run on a mobile computing device (e.g., one configuration for device 220), such as iOS, ANDROID, WINDOWS Phone, TIZEN, SYMBIAN, and/or the like.

As explained supra, the GUI of the device 336 may provide a baseline and means of accessing and displaying information graphically to users. The GUI may include APPLE MACINTOSH Operating System's AQUA, IBM's OS/2, Microsoft's WINDOWS 2000/2003/3.1/95/98/CE/MILLENNIUM/NT/XP/Vista/7 (i.e., AERO), UNIX'S X-Windows (e.g., which may include additional UNIX graphic interface libraries and layers such as K DESKTOP ENVIRONMENT (KDE), MYTHTV and GNU Network Object Model Environment (GNOME)), web interface libraries (e.g., ActiveX, AJAX, (D)HTML, FLASH, JAVA, JAVASCRIPT, etc. interface libraries such as, but not limited to, DOJO, JQUERY(UI), MOOTOOLS, PROTOTYPE, SCRIPT.ACULO.US, SWFOBJECT, or YAHOO! User Interface, any of which may be used.

Additionally, a web browser component (not shown) is a stored program component that is executed by the CPU. The web browser may be a conventional hypertext viewing application such as MICROSOFT INTERNET EXPLORER, EDGE, CHROME, FIREFOX, or NETSCAPE NAVIGATOR. SECURE WEB browsing may be supplied with 128 bit (or greater) encryption by way of HTTPS, SSL, and/or the like. Web browsers allowing for the execution of program components through facilities such as ACTIVEX, AJAX, (D) HTML, FLASH, JAVA, JAVASCRIPT, web browser plug-in APIs (e.g., FIREFOX, SAFARI Plug-in, and/or the like APIs), and/or the like. Web browsers and like information access tools may be integrated into PDAs, cellular telephones, and/or other mobile devices.

A web browser may communicate to and/or with other components in a component collection, including itself, and/or facilities of the like. Most frequently, the web browser communicates with information servers, operating systems (such as the operating system 226), integrated program components (e.g., plug-ins), and/or the like; e.g., it may contain, communicate, generate, obtain, and/or provide program component, system, user, and/or data communications, requests, and/or responses. Of course, in place of a web browser and an information server, a combined application may be developed to perform similar functions of both. The combined application would similarly affect the obtaining and the provision of information to users, user agents, and/or the like from the enabled nodes of the present invention.

Moreover, the computing device 336 may have additional features or functionality, and additional interfaces to facilitate communications between the basic configuration and any desired devices and interfaces. For example, a bus/interface controller is used to facilitate communications between the basic configuration and data storage devices via a storage interface bus 302. The data storage devices may be one or more removable storage devices, one or more non-removable storage devices, or a combination thereof. Examples of the one or more removable storage devices and the one or more non-removable storage devices include magnetic disk devices (such as flexible disk drives and hard-disk drives (HDD)), optical disk drives (such as compact disk (CD) drives or digital versatile disk (DVD) drives), solid state drives (SSD), and tape drives, among others. Data stores and/or repositories 128, 154, and 164 are data storage devices shown in FIG. 1.

In some embodiments, an interface bus facilitates communication from various interface devices (e.g., one or more output devices 338, one or more peripheral interfaces 346, and one or more communication devices 354) to the basic configuration via the bus/interface controller 310. Some of the one or more output devices 338 include a graphics processing unit 340 and an audio processing unit 344, which are configured to communicate to various external devices, such as a display or speakers, via one or more A/V ports 342.

The one or more peripheral interfaces 346 may include a serial interface controller 350 or a parallel interface controller 352, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 348.

Further, the one or more communication devices 354 may include a network controller 356, which is arranged to facilitate communication with one or more other computing devices 360 over a network 210 communication link via one or more communication ports 358. The one or more other computing devices 360 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

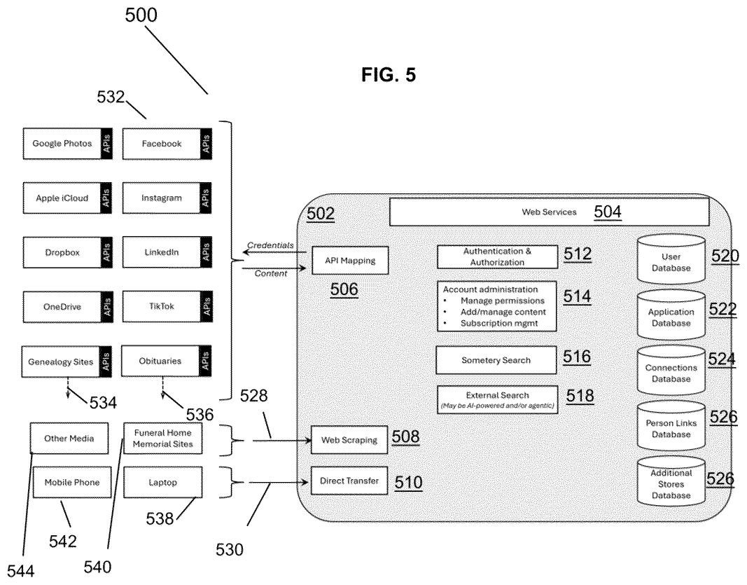

It should be appreciated that the system memory 332, the one or more removable storage devices 304, and the one or more non-removable storage devices 306 are examples of the computer-readable storage media. The computer-readable storage media is a tangible device that can retain and store instructions (e.g., program code) for use by an instruction execution device (e.g., the computing device 336). Any such, computer storage media is part of the computing device 336. FIG. 5 illustrates a system architecture 500 configured for aggregating, processing, and storing digital content from various external sources. The system is divided into several components, including external data sources, a processing and integration layer, web services, and databases. The external data sources include social media platforms, cloud storage services, genealogy sites, and obituary databases, all of which are accessed via one or more APIs 532. Examples of these sources include Google Photos, Apple iCloud, Dropbox, OneDrive, Facebook, Instagram, LinkedIn, and TikTok. Additionally, genealogy sites and obituary repositories contribute historical and memorial-related data 534, 536. Beyond online platforms, the system integrates with funeral home memorial sites 540 and personal media devices such as mobile phones 542, laptops 538, and other external media sources 544, allowing for a comprehensive aggregation of digital content. Data from these sources is acquired through API-based integration 528, 530, web scraping 508, or direct transfer 510, ensuring flexibility in data retrieval.

Once collected, the processing and integration layer 502 manages the organization and security of the digital content. API mapping 506 ensures that data from different platforms is formatted correctly for integration. Authentication and authorization 512 secure user access and enforce role-based permissions. Account administration 514 enables users to manage their permissions, upload or modify content, and oversee subscription services. The system also incorporates search functionality, including Sometery search 516 and external search 518, which may use AI and/or agent-based methods to locate additional relevant content.

The web services layer 504 serves as the system's backbone, facilitating communication between different components. This layer enables secure authentication, data synchronization, and user interactions with stored content. The databases 520 through 526 house and organize the aggregated data. The user database 520 stores account details, while the application database 522 manages system functionality. The connections database 524 maps relationships between users and their associated content, and the person links database 526 records linked connections between individuals. Additionally, an extra storage database 526 holds supplementary data that does not fit within other classifications.

### EXAMPLES

In an embodiment, the system employs a digital cemetery where an appointed executor can manage and preserve social media content in a structured manner. Users can belong to multiple digital resting places, such as those designated for family, work, and/or religious groups, facilitating content is accurately categorized and accessible only to relevant audiences. The platform curates content, retaining meaningful posts while respecting privacy settings. It retrieves, indexes, and stores data from multiple social media platforms, allowing for a comprehensive digital legacy.

In an embodiment, controlled access across that different groups, such as family, friends, and coworkers, is employed so that a predetermined group and/or groups may see predetermined and/or relevant content. Executors can filter and/or modify content before making it accessible, maintaining a respectful and secure environment. A subscription-based model supports the longevity of the service beyond the policies of individual social media providers. Strategic partnerships with cemeteries, estate planners, and social media platforms further enhance its integration and effectiveness.

In an embodiment, the platform is built on a structured database that organizes social media content based on at least, relationships and permissions. Executors have varying levels of control to manage the digital legacy, ensuring that only appropriate content is retained. The system can integrate with existing social media accounts or function independently as a repository for digital memories. This system provides a structured and respectful way to manage digital legacies, so that social media content is preserved, organized, and accessible to appropriate audiences after a person's passing.

The RP platform is configured to manage a deceased user's digital presence by handling social media accounts, content, and personal data according to pre-established conditions. Users can appoint RP Executors to manage their digital assets posthumously. The system securely stores login credentials and passwords for various social media platforms and enables the user to define an RP Will, setting conditions for data retention, deletion, and content visibility. Customizable access allows different groups to interact with a digital resting place in a way that aligns with their relationship to the deceased. For example, family members may have access to personal photos and messages, while colleagues can view professional achievements. Granular access controls enable unions or intersections of content to be tailored to different groups. Social media transition services 220 facilitate account modifications 222, including memorializing, deleting, or managing accounts based on platform policies. The platform extracts and stores social media content in a dedicated repository, allowing for continued engagement through memorial posts or limited posthumous interactions. Executors can manage posts, messages, and interactions to ensure a respectful digital legacy. Postmortem content and communication features allow for automated notifications to designated individuals, ensuring that important updates, such as remembrance events and anniversaries, are shared appropriately. Executors can curate content 224, moderate messages, and create digital memorials, such as obituaries, timelines, and tribute videos. Data security is a priority, with encryption, archiving, and data compression ensuring privacy. Sensitive information is sanitized, and controlled decryption options are provided for executors. Partnerships 170 with social media providers streamline post-death account handling, allowing for integration with existing platforms. Affiliate portals 240 enable content to be linked to external websites such as Wikipedia or cemetery databases. AI-driven features 246 enhance the curation and grouping of content, enabling automated tagging and indexing. The system can even facilitate AI-based simulations that allow for interactions with the deceased's digital persona, creating a more immersive and meaningful memorial experience. Administrative controls 244 provide executors with analytics, subscription management, and access tracking.

The social media account content curation module 224 gathers content from one or more accounts of a user 110 and stores it in the RP repository 164. AI tools assist in filtering, sorting, and tagging relevant content, ensuring that only meaningful material is preserved. Executors can apply encryption and data compression to balance security and accessibility. The curation module 224 also allows for content deletion in accordance with social media provider policies and state laws, ensuring compliance while maintaining user preferences. The RP postmortem content enablement module 230 dynamically notifies individuals of a user's passing and moderates the content posted by others. Executors can control the narrative of the digital memorial by curating new content and delegating responsibilities to family members or trusted individuals. The RP platform centralizes and/or automates digital legacy management, reducing the burden on grieving families while ensuring that the deceased's wishes are honored. By integrating with social media, enabling controlled posthumous communication, and leveraging AI for enhanced digital afterlife experiences, it provides a comprehensive solution for preserving and organizing a person's online presence.

In an embodiment, the system is built on a computing infrastructure that includes processors, system memory, and a memory bus for efficient data communication. System memory consists of both volatile and non-volatile storage, housing the operating system and essential program data. The graphical user interface provides an experience for users, incorporating web-based tools for easy management. Communication components enable interaction with external networks, allowing for integration with social media platforms and cloud storage solutions. The platform's architecture supports multiple storage options, including removable and non-removable media, ensuring reliability and redundancy. The processor executes instructions stored in memory, performing tasks necessary for data curation, encryption, and retrieval. The system supports various programming languages, enabling adaptability across different hardware and software environments.

The digital cemetery provides a structured approach to preserving a deceased individual's social media presence. A designated space within the platform indexes and categorizes content from multiple accounts, ensuring controlled access for different groups. Some social media accounts may be deactivated upon death, while selected content remains accessible in the resting place repository. The deceased or their executor can determine which content is preserved or removed, ensuring that sensitive information is handled appropriately. Family and work-group plots support collective remembrance, allowing groups to share memories in a meaningful way. Communication features enable group members to engage in discussions and commemorate the deceased within the platform. This system creates a controlled digital legacy, facilitating a respectful and organized approach to managing a deceased person's social media presence.

The RP platform operates using a combination of hardware components such as cloud servers, high-performance computing systems, and storage devices to manage and process digital legacy data efficiently. Cloud servers handle large-scale data storage and retrieval, ensuring content remains accessible over time. AI accelerators, such as NVIDIA GPUs and Google's Tensor Processing Units (TPUs), enhance the processing of AI-driven features, enabling rapid content analysis and organization. Secure storage solutions, including encrypted solid-state drives (SSDs) and redundant array of independent disks (RAID) configurations, help preserve data integrity and prevent unauthorized access.

AI-driven features enhance the curation and grouping of content by leveraging machine learning models to analyze text, images, and metadata across a user's social media history. Natural language processing (NLP) algorithms identify recurring themes, sentiment, and figures in a user's digital interactions, automatically tagging and categorizing posts based on relevance. For example, AI can distinguish between professional achievements shared on LinkedIn, family-related content on Facebook, and personal reflections posted on Twitter. Computer vision models further aid in recognizing faces, locations, and objects in images and videos, allowing automated indexing of visual memories. Additionally, AI-powered recommendation engines suggest meaningful ways to organize and display content for different groups. If a user frequently posted about workplace achievements, the system can group relevant content into a “Professional Legacy” category accessible to coworkers. Similarly, family-oriented photos and messages can be categorized under “Family Memories” for relatives. Over time, machine learning models refine their accuracy by learning from executor preferences, ensuring that content is sorted and presented in ways that align with the deceased's wishes.

The RP platform provides a technological improvement by automating the management, curation, and controlled distribution of a deceased user's digital presence. Traditional digital estate management requires manual intervention, making it cumbersome, inconsistent, and vulnerable to security risks. The RP platform overcomes these challenges by introducing AI-driven automation, secure data handling, and group-based access control to enhance digital asset management. The system employs machine learning algorithms and natural language processing to analyze, categorize, and tag digital assets based on content type, metadata, and contextual relevance. Unlike conventional digital repositories that rely on manual sorting, the RP platform provides an AI-enhanced automated curation mechanism, reducing the time and effort required to organize digital assets. Additionally, computer vision enables automated indexing of visual content, improving the searchability and retrieval of meaningful digital memories.

The platform implements a hierarchical and customizable access control system, ensuring that different groups, such as family, coworkers, or friends, receive tailored access to specific subsets of digital content. Unlike generic access control lists that apply broad, static permissions, the RP system introduces real-time access configuration through dynamic unions and intersections of content categories based on contextual relevance. This enables secure and granular control over digital assets, ensuring compliance with user-defined preferences while maintaining data privacy. Furthermore, the platform securely stores authentication credentials and passwords in an encrypted environment, such as hardware security modules or secure enclaves. The RP Will mechanism ensures that digital credentials are handled based on predefined conditions and cryptographic key management, preventing unauthorized access and mitigating risks associated with account hijacking.

To support scalability and real-time processing, the system leverages distributed cloud computing and parallel processing architectures to efficiently manage vast amounts of digital content. AI accelerators, such as GPUs and TPUs, ensure fast and efficient processing of AI-driven curation tasks, providing a real-time and scalable solution for digital estate management. These technical advancements go beyond merely implementing an abstract idea, such as managing digital assets, and instead provide a specific technological solution to a problem rooted in computing-namely, the automated and secure posthumous management of digital accounts and content. By improving computer functionality through AI-powered content curation, dynamic access controls, and secure data management, the RP platform presents a practical application of technology rather than an abstract concept. As a result, the system demonstrates a concrete technical effect on computer functionality, by offering a specific, inventive, and technological improvement to conventional digital estate management.

### EXAMPLES

The Sometery platform is configured to manage and curate content for both living and deceased individuals in a single location, providing an integrated and user-friendly experience. The platform allows users to aggregate content from various sources, both external and internal. For example, content from social media platforms like Facebook or Instagram can remain within the native applications, preserving the original context, while content from personal devices such as mobile phones or laptops can be uploaded directly into the application. This integration allows users to manage and organize all types of content in one location. The Sometery platform is configured for users to create and share personal anecdotes, messages, and information. In an embodiment of the platform is the ability for individuals to leave messages for family and friends, as well as for family and friends to contribute their own memories or thoughts about the individual. This fosters a shared space for both the living and deceased to interact with their loved ones. The platform incorporates role-based permissions, allowing account owners to control who can view specific content. For instance, a family member may be able to view certain content that a friend cannot, ensuring privacy and selective sharing.

To source content, Sometery integrates with external data repositories like Facebook, LinkedIn, and others, pulling data through application programming interfaces (APIs). In cases where external services cease to exist or where technical or licensing issues arise, Sometery may replicate this data within its platform, reducing licensing complications while maintaining access to valuable content. The platform's approach rewards original platforms by driving users back to those external services when necessary. Additionally, local copies of data from personal devices, such as a phone or computer, can be uploaded and stored within Sometery to preserve and organize personal content. For content that may not be intended for long-term curation, web scraping is used to extract relevant material. The platform is structured to manage a variety of data types across logically distinct databases, though the physical implementation may vary. For example, there are separate data categories for users, permissions, subscription statuses, and connection information between Sometery and external APIs. The platform also maintains person-level data, such as medical history, burial location, anecdotes, and other materials contributed by friends and family.

As a modern, cloud-hosted application, Sometery ensures adaptability across various devices, including laptops, tablets, and mobile phones, providing a consistent user interface. One of the platform's features is the automation of metadata creation, including content summaries, which enhances searchability and facilitates content organization. For users with sufficient audio and video content, Sometery can generate a virtual representation of the individual, allowing them to “speak,” read, and interact with users. If enough source material is available, the virtual representation could even present the individual at different ages, offering a more dynamic and personalized experience.

In addition to personal content, Sometery supports the inclusion of locations associated with the honoree, such as interment locations or former residences. These locations can be documented with photographs, GPS coordinates, or references from services such as What3Words.

Privacy is a core consideration in the Sometery platform. The system collects and retains only the information necessary to deliver services, ensuring that users' personal data remains protected. If an issue arises regarding content associated with an individual, users have the ability to petition the original source for linked resources or appeal to the account administrator for resolution. If further action is required, users can escalate the matter to the application administration, ensuring a fair process for all parties involved. This structure ensures that Sometery remains a secure, efficient, and flexible platform for managing both living and deceased individuals' content.

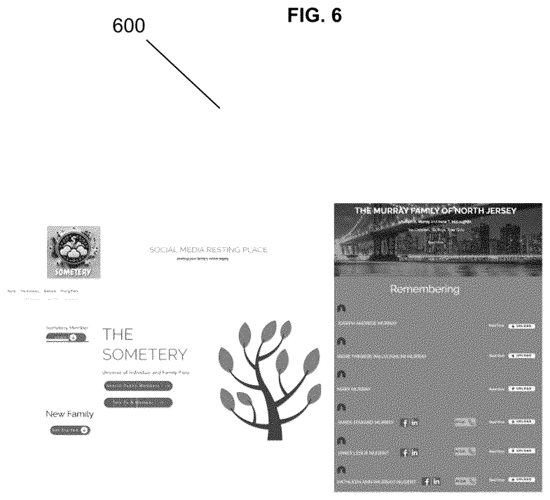

FIG. 6 illustrates a user interface 600 for a digital platform for the resting place server application of FIG. 2, where individuals can preserve and manage family legacies online. The left side of the figure displays the homepage of “The Sometery,” a platform that enables users to create and manage digital memorials for family members. The interface includes options to establish new family connections, maintain individual and family plots, and manage digital tributes. A stylized tree graphic represents a family tree, reinforcing the theme of genealogy and interconnectedness. On the right side of the figure, a specific example of a family memorial page is shown for “The Murray Family of North Jersey.” This page serves as a digital remembrance space, listing family members along with their associated social media links, including Facebook and LinkedIn, as well as call and chat functionalities. The interface allows users to interact with and explore their family's history while maintaining connections with living relatives. The layout is configured for ease of use, with a clean and structured presentation of family relationships, memorialization features, and interactive elements.

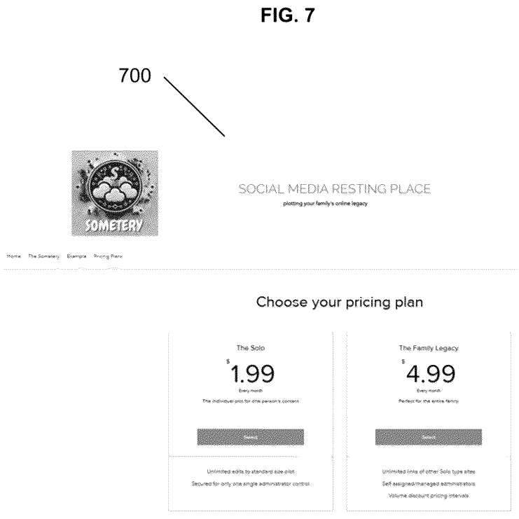

FIG. 7 illustrates a user interface 700 for a digital platform for the resting place server application of FIG. 2, displaying the pricing plans of “The Sometery,” a digital platform configured as a “social media resting place” for preserving family legacies online. The top of the interface features the platform's logo and tagline, “plotting your family's online legacy,” reinforcing its purpose as a digital memorial space. Below this, users are given the option to choose between two pricing plans: “The Solo” and “The Family Legacy.” “The Solo” plan is priced at $1.99 per month and provides an individual digital plot for one person's content. It includes unlimited edits to a standard-sized plot and is secured for a single administrator's control, ensuring privacy and personal management of the memorialized content. “The Family Legacy” plan, priced at $4.99 per month, is configured for entire families and offers additional features. It allows unlimited links to other Solo-type sites, enables self-assigned and managed administrators, and provides volume discount pricing intervals for users managing multiple memorial pages. The layout of the interface is clean and user-friendly, making it easy for potential users to compare the two pricing options and select. The structured design emphasizes accessibility, allowing users to manage and preserve their family's digital presence according to their needs.

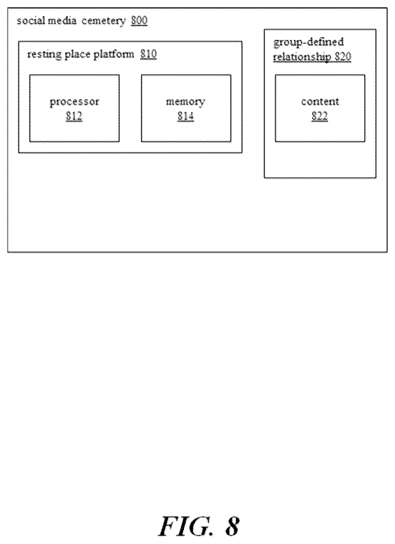

FIG. 8 illustrates a block diagram that illustrates a social media cemetery 800, according to certain embodiments of the present disclosure. In some embodiments, the social media cemetery 800 may include a resting place platform 810 and a group-defined relationship 820 with the deceased individual. The resting place platform 810 serves as the core component for managing the digital afterlife of the deceased, allowing for a transition from the individual's active social media presence to a memorialized state. It includes a processor 812 and a memory 814 storing computer-readable instructions that, when executed by the processor 812, cause the computing device to perform various functions aimed at maintaining and preserving the individual's digital presence after their passing.

The processor 812, for example, can handle requests for updating or modifying the deceased's profile across different social media platforms. When a loved one or a designated representative interacts with the platform, the processor may trigger notifications or prompts to guide users through various options such as adding tribute posts, curating photo albums, or sharing the memorial across other social media networks. These interactions are stored in memory 814, which also maintains records of any content added, edited, or removed. Memory 814 can also hold the group-defined relationship 820, a feature that allows family members, friends, and other acquaintances of the deceased to define their connection to the individual, such as by categorizing their relationship as family, friend, colleague, or acquaintance.

This group-defined relationship 820 also enables the platform to tailor content and notifications based on these connections. For instance, family members may have access to more personal content like private messages, photo galleries, and videos, while acquaintances or broader social circles may only be able to interact with public posts and memorials. Additionally, the group-defined relationship 820 might allow for specific permissions for each group, ensuring that individuals are given the ability to contribute in ways that respect the wishes of the deceased and their family. This could include setting restrictions on who can post or comment on certain content, thus maintaining the integrity of the deceased's digital space.

Furthermore, the resting place platform 810 might support a feature that automatically sends out notifications on anniversaries, such as the deceased's birthday or the anniversary of their passing. These notifications could be targeted to specific groups based on their relationship with the deceased, allowing for personalized and meaningful interactions. For example, close family members might receive a reminder to light a virtual candle or share a memory, while friends may receive a general reminder to engage with the memorial page. Additionally, the resting place platform 810 could integrate with various social media channels, offering users the ability to share posts from the social media cemetery on their own personal profiles, thereby encouraging collective remembrance.

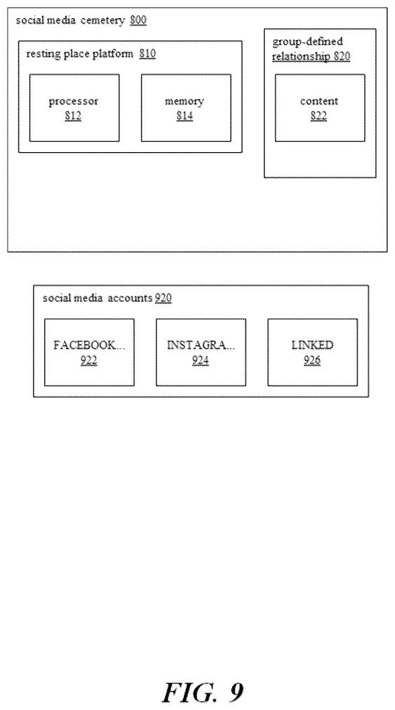

In one embodiment, the social media cemetery 800 may also provide a feature where users can engage in real-time, virtual commemorations, such as online memorial services or live-streamed tributes, providing a space for loved ones to come together despite geographical distances. These services could be facilitated by the processor 812, which could handle video streams, facilitate chats, and manage digital environments where friends and family can participate in interactive memorials or ceremonies. When executed by the processor 812, these instructions cause the computing device to perform the steps as described in FIG. 9.

FIG. 9 illustrates an additional aspect of the social media cemetery 800 from FIG. 8, showing the types of social media accounts 920, which may include Facebook 922, Instagram 924, and LinkedIn 926. A computing device may establish a digital cemetery plot for a deceased individual, who, while alive, was an account holder of multiple social media accounts 920, each provided by a different social media platform. The resting place platform 810 provides the digital cemetery plot, which indexes content 822 (FIG. 8) from the social media accounts 920 into various group categories. The group-defined relationship 820 may involve content 822 from multiple social media accounts 920. A first portion of content from the social media accounts 920 may be associated with a first group, while a second portion may be associated with a second group. The content of these portions may come from more than one of the social media accounts. When an access request is made from a first computing device, the system determines if the user belongs to the first group and provides access to the corresponding content. Similarly, when an access request is made from a second computing device, the system checks if the user belongs to the second group and provides access to the appropriate content.

In some embodiments, the first group may consist of the deceased's immediate family, and the second group may consist of extended family members. Alternatively, the first group could be the deceased's family, and the second group could be work-related peers. In these cases, the first group had access to the first portion of content during the deceased's life, while the second group had access to the second portion.

In some embodiments, upon the death of the individual, some social media accounts 920 may be disabled, rendering their content inaccessible to both groups unless the content is accessed through the resting place platform 810. Furthermore, executing the instructions stored in memory may involve collecting content from the social media accounts 920 and storing it in a resting place repository.

The digital cemetery plot may offer users a choice of social media account types. Depending on the selection, different subsets of the first and second content portions may be displayed. For instance, a subset may be shown based on a particular social media account type selected by the user. In certain embodiments, the digital cemetery plot could be part of a family digital cemetery plot. The resting place platform 810 may remove content from the social media accounts 920 that is not relevant to at least one of the group categories. After the individual's death, any potentially negative content may be permanently inaccessible. The executor of the deceased's estate may determine what constitutes potentially negative content before it is removed. Additionally, the processor 812 may assign administrative control of the digital cemetery plot to an executor appointed by the deceased while they were alive. The digital cemetery plot may be part of larger family and work-group cemetery plots, each created by the resting place platform 810.

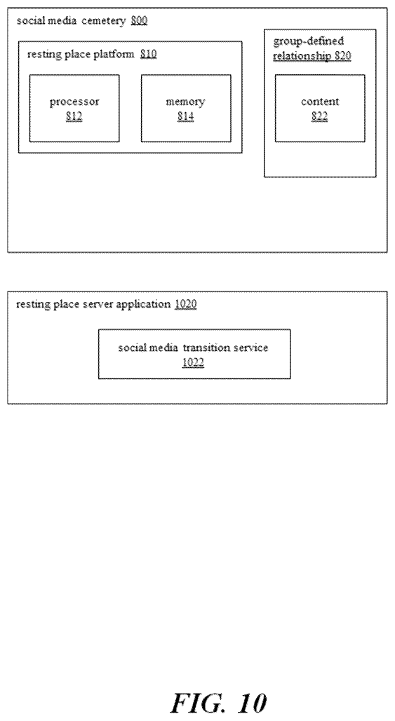

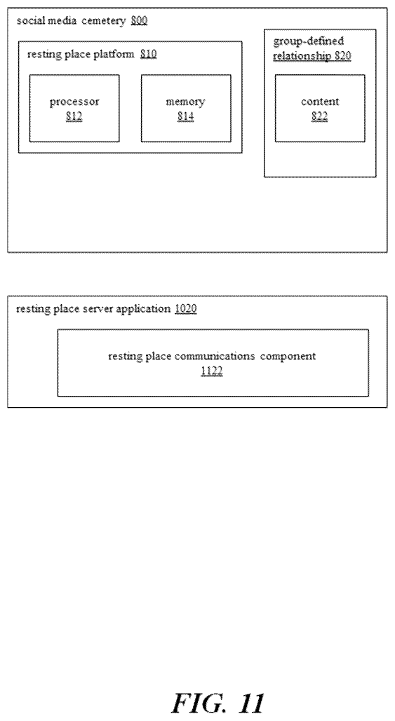

FIG. 10 provides further details, showing that the resting place platform 810 includes a resting place server application 1020, which may incorporate a social media transition service 1022. This service facilitates managing the digital footprint of the deceased individual by transitioning their social media accounts 920 to reflect their death. Upon notification of the individual's passing, the social media transition service 1022 automatically changes account statuses to “memorialized” or “in remembrance,” depending on the policies of the respective social media platforms. The service may then curate and archive content from the individual's social media pages, ensuring that photos, posts, and personal stories are preserved in a manner that is respectful and dignified. It may also offer options for users to specify which posts or media they want to be highlighted, such as important milestones or life events that define the individual's legacy.

Additionally, the service could allow family members or designated representatives to add or edit content in a controlled environment, ensuring that the individual's digital legacy aligns with their family's wishes. For example, loved ones might want to post a final message or tribute, or perhaps share a favorite photo that was not previously uploaded. The social media transition service 1022 might also enable the creation of a memorial page, where friends and family can contribute their memories, share condolences, and engage in a collective remembrance experience. Furthermore, the service could provide an option for friends or family to deactivate the account after a certain period, based on the wishes of the deceased or their loved ones.

The resting place server application 1020 might include a feature that curates the content stored in the resting place repository, organizing it by categories such as personal milestones, family events, and friendships. In this way, the platform provides a living digital archive that offers not just a memorial, but a meaningful collection of the individual's interactions and memories over time. It could also include an emotional connection feature, where posts or videos that were most shared or commented on are highlighted to reflect the lasting impact the individual had on others.

Additionally, notifications could be sent periodically to friends and family, reminding them of anniversaries or dates related to the deceased, fostering continued connection and remembrance. Through these services, the resting place platform offers a holistic and respectful approach to managing a person's online legacy.

FIG. 11 illustrates another component of the resting place platform 810, the resting place communications component 1122. This component facilitates communication between members of the first and second groups regarding the deceased individual, allowing them to share memories, condolences, and updates. For example, the communications component 1122 enables members to send memorial messages, tributes, and multimedia content such as photos, voice notes, or videos to one another. It also supports the organization of collaborative remembrance events, such as virtual memorial services or physical gatherings, fostering a sense of community in the grieving process. Additionally, the component provides discussion forums or group chats where members can share stories and offer emotional support, either privately or within designated groups. Furthermore, it may allow for the creation of a shared timeline that commemorates the deceased individual's life, marking milestones, anniversaries, and other events important to the members of both groups. Grief support tools are also integrated into the platform, providing access to professional counseling or support networks for those in need. The communications component 1122 could also feature a shared memory bank where members contribute personal anecdotes, photos, or videos of the deceased, preserving the individual's legacy. Finally, it may send automated anniversary notifications, reminding both groups of dates such as birthdays or anniversaries, ensuring that the memory of the deceased remains alive within the community. Through these features, the resting place communications component 1122 maintains connections and offers ongoing support throughout the grieving process.

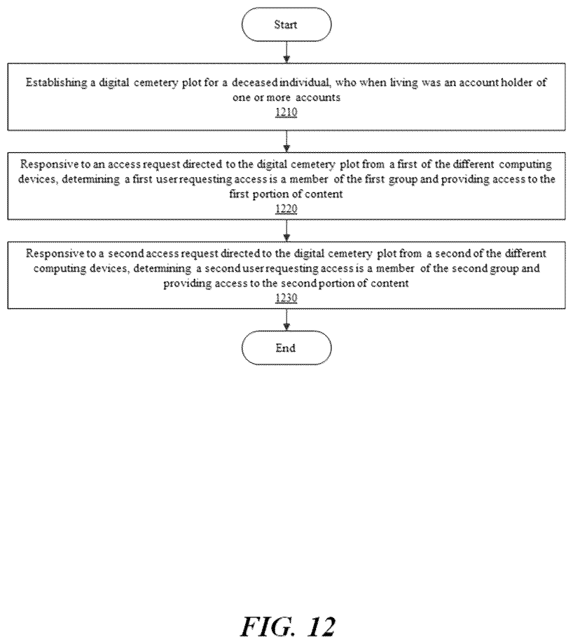

FIG. 12 describes a method for retaining social media content, according to some embodiments. At block 1210, a digital cemetery plot is established for a deceased individual who held accounts on multiple social media platforms. This digital cemetery plot serves as a comprehensive virtual archive of the deceased individual's online presence, encompassing their profiles, posts, images, and any other digital interactions they engaged in during their lifetime. By creating this virtual plot, the method ensures that the deceased individual's digital footprint is preserved and accessible to authorized individuals, allowing for continued remembrance and interaction with the individual's online identity long after their passing. The plot may be stored on secure servers, utilizing encryption and data protection measures to safeguard the content from unauthorized access.

At block 1220, responsive to an access request directed to the digital cemetery plot from a first of the different computing devices, determining a first user requesting access is a member of the first group and providing access to the first portion of content. In certain embodiments, the first group may include close family members or lifelong friends who had a deep personal connection with the deceased individual. These users would be granted access to a more private or intimate portion of the content, which may include personal messages, private group posts, and photos or videos that were shared with limited audiences while the individual was alive. For example, a spouse might be able to access and view a private diary or personal messages shared only between the deceased and their closest family members. This level of access allows these users to interact with the deceased's content in a more meaningful and personal way, preserving intimate memories and facilitating a more personal mourning process.

At block 1230, responsive to a second access request directed to the digital cemetery plot from a second of the different computing devices, determining a second user requesting access is a member of the second group and providing access to the second portion of content. The second group may consist of acquaintances, colleagues, or distant relatives who had a less personal relationship with the deceased individual but still wish to pay their respects or reflect on the deceased's life. These users may be granted access to a more general portion of the content, such as publicly available posts, professional achievements, public photos, or general memorial information. For instance, a co-worker may view a post celebrating the deceased's work achievements or a public photo that the individual shared during their lifetime. This portion of the content is meant to facilitate community-wide mourning and remembrance while ensuring that more sensitive content is restricted to those who had a closer relationship with the individual.

Additionally, the method described in FIG. 12 allows for the customization of access permissions for both groups. For example, family members in the first group may be able to upload new content to the digital cemetery plot, such as new messages, photos, or videos, continuing to share memories even after the individual has passed. In contrast, users in the second group may only be permitted to leave tributes or comments but not modify or upload content. This access model ensures that the digital cemetery plot remains a respectful and controlled space, with users' interactions governed by their relationship to the deceased individual and the content's sensitivity.

The method also provides for maintaining the integrity of the digital cemetery plot over time. For instance, if new information or content becomes available through digital archives or other sources, the system can allow for the addition of this content in a way that ensures the memorial remains up to date and comprehensive. This could include new social media content discovered after the individual's passing or contributions from additional family members or friends. The method ensures that all additions are logged and, if necessary, reviewed by the designated administrator of the digital cemetery plot before becoming publicly accessible, preserving both the authenticity and respectfulness of the memorial.

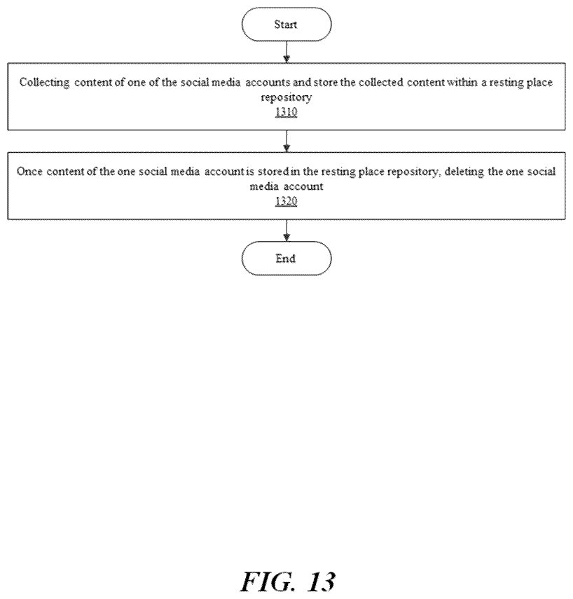

FIG. 13 further details the method from FIG. 12, at block 1310, outlining steps to collect and store content from social media accounts in a resting place repository. This step involves gathering digital content, including posts, photos, videos, messages, and any other relevant media from various social media platforms where the deceased individual had active accounts. The system identifies and retrieves data from these accounts, which may include public and private content, depending on the user's privacy settings. The collected data is then securely transferred and stored in the resting place repository—a dedicated storage system configured specifically for preserving the digital legacy of the deceased individual. This repository acts as a digital archive that organizes the content, ensuring it is easily accessible to authorized users while maintaining data integrity and security. The stored content could be categorized based on platform type (e.g., Facebook, Twitter, Instagram) or by the nature of the content (e.g., family photos, work-related posts, public engagements), allowing users to navigate the repository in a meaningful way.

In certain embodiments, the system may automatically categorize and tag the content to ensure that users can find specific memories or interactions related to the deceased. For example, the system might create separate sections in the repository for different stages of the individual's life, or it may group content based on themes like family, career, or hobbies. Additionally, the content can be curated to highlight moments in the individual's life, such as accomplishments, important events, or memorable experiences shared with loved ones. This method of storing social media content ensures that the digital legacy is not only preserved but also organized in a way that helps users to reflect on the deceased individual's life in a structured, meaningful manner.

At block 1320, the method proceeds to delete the original social media account after the content is stored. Once the content is successfully collected and stored in the resting place repository, the system proceeds to deactivate or delete the deceased individual's original social media accounts to prevent unauthorized access or misuse of the account. Deleting the account is a step in ensuring that the individual's online presence is appropriately handled following their passing. This step may be automatically triggered once the system verifies that the data has been securely transferred to the resting place repository. By deleting the account, the system reduces the potential for impersonation or any unwanted interaction with the account, such as spam or fraudulent activity.

In certain embodiments, this deletion process may be conducted in coordination with the policies of the social media platforms themselves. Some social media platforms provide a “memorialization” option, which locks the account and converts it into a memorial page without deleting it, allowing only authorized individuals to post on the account. In these cases, the system may communicate with the social media platform to ensure that the account is memorialized properly while the content is still stored securely in the resting place repository for future access.

This approach provides a respectful transition of the individual's social media presence while ensuring that their content remains preserved in a private and controlled environment. Additionally, the method could involve notifying the designated family members or administrators about the successful deletion of the account and the storage of its content, providing transparency and control over the entire process.

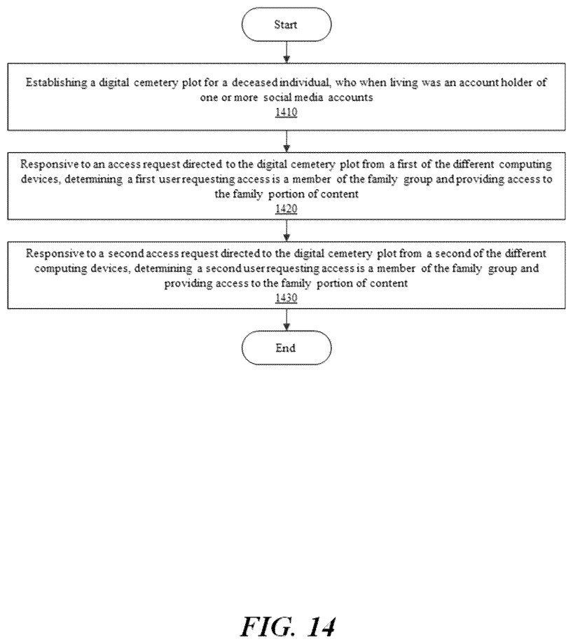

FIG. 14 expands on the previous method, with specific content access based on group membership, where the first group consists of family and the second group of work-related peers. At block 1410, the method begins by establishing a digital cemetery plot for a deceased individual, who, during their lifetime, was an account holder on multiple social media platforms. These accounts may have contained personal content, professional updates, or other digital media that represent different aspects of the individual's life. The digital cemetery plot is managed by a resting place platform, which organizes and indexes the content from the social media accounts according to various group categories, each associated with a group-defined relationship to the deceased. For instance, the platform may categorize the content into family, work, or other social groups, reflecting the different types of relationships the deceased had with their audience. A family portion of content, including personal photos, messages, and family-related posts, is associated with the family group. Similarly, a work portion of content, such as professional achievements, industry-related posts, and communications with colleagues, is associated with the work group. These portions are drawn from multiple social media accounts, allowing the family and work groups to access the specific content relevant to their connection with the deceased, while maintaining privacy and control over the content shared with each group.

At block 1420, the method proceeds by responding to an access request directed to the digital cemetery plot from a first of the different computing devices. The system evaluates the access request and determines that the first user requesting access is a member of the family group. Upon verification, the system grants the user access to the family portion of content, which may include private messages, family photos, and memories that were shared only within the family network. The content provided to the family group is curated to ensure that it is emotionally significant and appropriate for the members of this group. This selective access ensures that family members can reminisce, share their grief, and reflect on the deceased's personal life while protecting their privacy from others who may not have the same familial connection.

At block 1430, a similar process occurs in response to a second access request, where a second user from a different computing device requests access to the digital cemetery plot. This time, the system evaluates the request and determines that the second user is a member of the work group. The work group content may include professional achievements, career-related milestones, and social media updates regarding the deceased's professional life. This portion is configured to cater specifically to colleagues, co-workers, and other professional peers who may have interacted with the deceased in a work-related capacity. Once the system confirms the user's membership in the work group, the work-related portion of content is made accessible to them. This ensures that professional memories and interactions with the deceased remain distinct from personal or family-related content, thereby respecting the boundaries between the deceased's personal and professional life.

The selective nature of the access process in FIG. 14 provides a personalized, secure, and respectful way to share content from the deceased's social media accounts while maintaining privacy and control over the distribution of that content. It allows family members to access emotionally significant materials, such as photos or personal messages, without risking exposure to work-related content or vice versa. Additionally, the separation of content into specific group categories helps ensure that each group experiences the deceased's legacy in a way that aligns with their relationship to the individual, providing a more meaningful and respectful way to preserve and share their digital footprint. This group-based access also ensures that sensitive content is handled appropriately, allowing the deceased's memory to live on in a manner that respects the nuances of their various social connections.

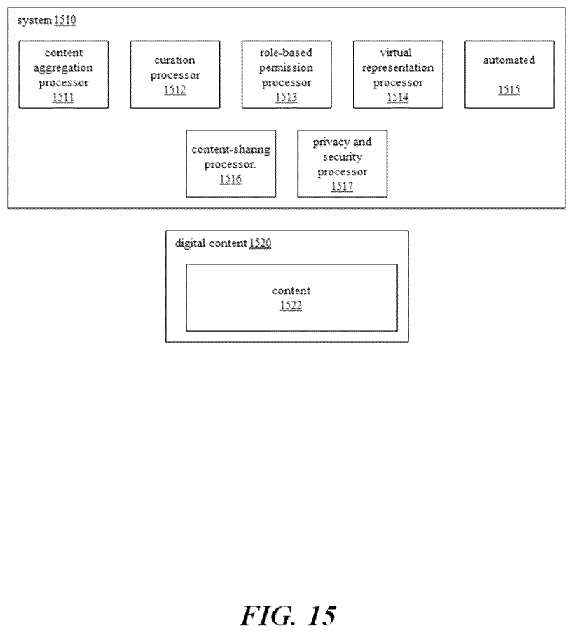

FIG. 15 is a block diagram that illustrates a system 1510 for managing and sharing digital content, according to some embodiments of the present disclosure. In this system, the content aggregation processor 1511 plays a central role by receiving and storing digital content 1520 from various external data repositories 1630, such as social media platforms, cloud storage, and other online sources. This processor also collects content from local devices, such as personal computers, smartphones, or digital cameras, ensuring that all available digital content is consolidated into one accessible repository. This aggregation ensures a comprehensive collection of data, including images, videos, texts, and other digital formats, that can be curated and categorized for future use.

Once the digital content 1520 is aggregated, the curation processor 1512 organizes the content into predefined categories. These categories might include family, work, public, or other personalized groupings that reflect the relationships between the content and its intended audience. For instance, photos might be tagged as “vacations” or “family gatherings,” while professional documents could be categorized under “career milestones” or “projects.” This organizational step allows for easier retrieval and sharing of content, ensuring that users can quickly locate and access the materials most relevant to them.

The role-based permission processor 1513 ensures that the system's access controls are appropriately set up, allowing only authorized users to view or interact with specific content based on their roles. For example, family members might have access to certain personal content, while colleagues may only be able to view professional or career-related materials. This role-based access control is essential for protecting sensitive or private information from unauthorized access, ensuring that users can engage with the system in a secure and controlled manner. By defining specific access permissions, the system allows for customized viewing experiences, allowing different user groups to interact with content in a way that aligns with their relationship to the deceased individual or their intended purpose for accessing the content.

Further enhancing the user experience, the virtual representation processor 1514 generates a digital avatar of an individual based on the digital content stored in the system. This avatar can be created from images, videos, and other media, allowing the deceased's likeness to be represented in a virtual form. The avatar can be utilized in various contexts, such as for memorial purposes, virtual celebrations, or as a conversational interface for family members and friends to interact with. The digital avatar serves as a way to preserve the individual's identity in a virtual space, providing users with a more immersive and personalized way to remember and engage with the individual's legacy.

The automated metadata generation processor 1515 enhances the searchability and organization of the digital content 1520 by generating metadata for each piece of content. This metadata could include details like the creation date, keywords, file type, and contextual information about the content. By automatically tagging content with metadata, the system enables users to easily search and filter through large volumes of digital materials. For example, users can search for specific events, people, or topics within the content, saving time and improving the efficiency of accessing desired items. Content sharing capabilities are handled by the content-sharing processor 1516, which allows users to share content with others based on predefined conditions. These conditions might include permissions granted by the content creator, the intended audience (e.g., family, friends, co-workers), or the content type. For example, a family member may choose to share personal photos of a deceased loved one only with immediate family, while professional achievements or career-related posts could be shared with colleagues or the public. The system thus enables content to be selectively distributed according to the user's wishes, preserving both privacy and the legacy of the deceased in a way that feels respectful and appropriate.

The privacy and security processor 1517 ensures that all user data and content are stored and accessed securely, adhering to user-defined privacy settings. This processor integrates encryption and secure authentication mechanisms to protect sensitive data from unauthorized access, ensuring that users can confidently store and manage their digital content in a secure environment. By providing granular privacy controls, the system allows users to dictate who can access specific types of content, enhancing the overall security of the platform and maintaining trust between users and the system. Whether for preserving a loved one's digital legacy or sharing personal memories, the privacy and security processor ensures that sensitive information remains safeguarded at all times. Together, these processors form an integrated system that allows for the management, sharing, and preservation of digital content in a secure and organized manner, ensuring that users can interact with the digital legacy of an individual in a way that respects their memory, privacy, and relationships.

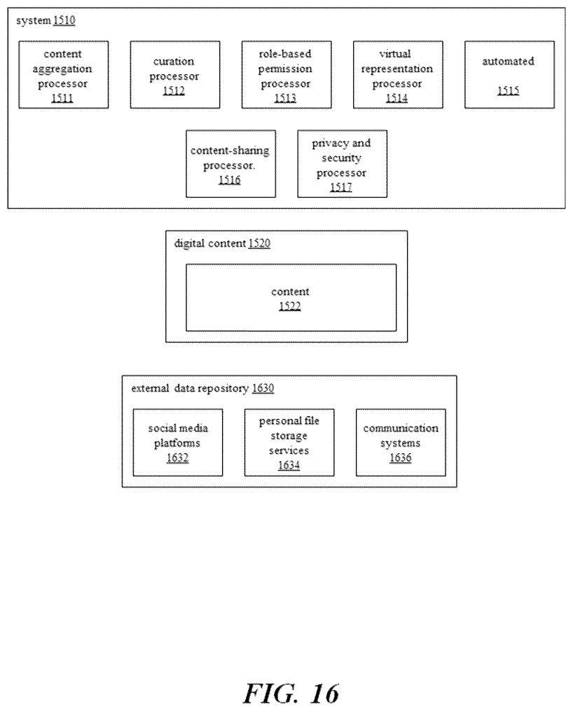

FIG. 16 expands on the system 1510 from FIG. 15, providing further details about the integration with external data repositories 1630, which are crucial for aggregating digital content. In some embodiments, the external data repository 1630 includes a variety of sources, such as social media platforms 1632, personal file storage services 1634, and communication systems 1636. Social media platforms 1632 might include popular services like Facebook, Instagram, and Twitter, where users share personal updates, photos, videos, and memories. Personal file storage services 1634 might consist of cloud-based storage systems like Google Drive, Dropbox, or OneDrive, which contain documents, images, and other personal data. Communication systems 1636 could include email accounts, messaging apps, or chat systems where individuals engage in direct conversations or store multimedia files.

The content aggregation processor 1511 plays a vital role by integrating with at least one API (Application Programming Interface) of the external data repositories 1630. This integration allows the system to fetch digital content from multiple external sources automatically. For instance, through APIs, the system could pull a user's posts from their social media accounts, photos and documents from their personal cloud storage, or archived conversations from communication platforms. By connecting to these APIs, the system ensures that all relevant digital content is aggregated into a central location, which is essential for creating a comprehensive digital legacy. As the content is gathered, the content aggregation processor 1511 organizes and tags it according to predefined categories, helping to create a streamlined and searchable repository. This tagging process enables easy access to content based on different user-defined criteria, such as “Family,” “Work,” “Friends,” and “Public,” or based on the type of content (e.g., “Photos,” “Documents,” “Videos”). Once the content is aggregated, it can be curated by the curation processor 1512 to ensure it is appropriately categorized for its intended audience, further enhancing the usability of the digital content repository.

In some implementations, the integration with external data repositories 1630 may also allow the system to automatically update and refresh the stored content, ensuring that new data is added as it becomes available. For example, when a user posts a new photo to their social media account, the content aggregation processor 1511 can retrieve and store this new photo in the digital repository, ensuring that the digital cemetery plot or memorial remains up-to-date. Similarly, if a user shares a new file on a cloud storage service, the system can capture and store it, ensuring all relevant materials are retained.

Moreover, the system is configured to handle content from various repositories for the efficient aggregation and storage of content across multiple sources. This system ensures that users do not need to manually collect content from each platform or storage service, offering a more automated and centralized approach to content management. By leveraging API integrations, the system simplifies the user experience while maintaining flexibility and adaptability to different digital environments. This also enhances the ability to maintain a complete, organized digital legacy, preserving memories, communications, and other content for future generations.

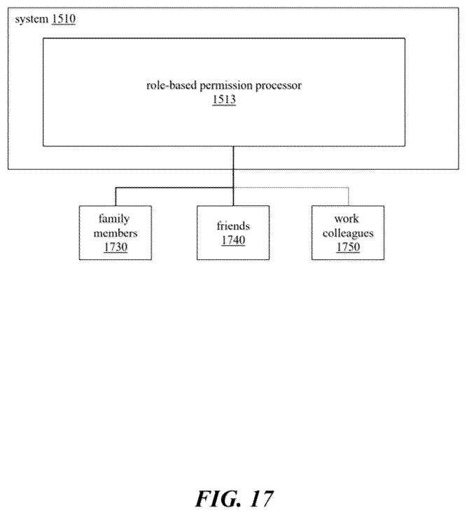

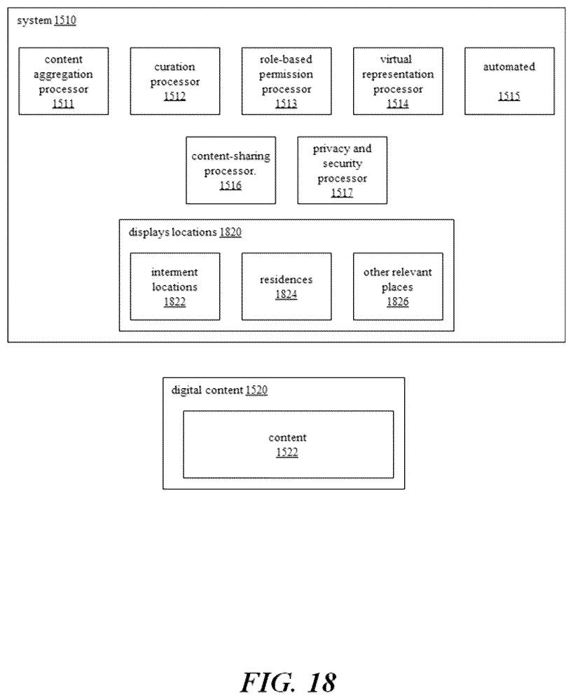

FIG. 17 provides a detailed breakdown of the role-based permission processor 1513, which is central to defining and controlling access to digital content within the system. In some embodiments, the role-based permission processor 1513 enables customized access controls based on user roles, allowing different users to access specific portions of content depending on their relationship with the deceased individual. For instance, family members 1730, friends 1740, and work colleagues 1750 are granted different levels of access to the digital content, ensuring that each group interacts with the content in a manner that respects the wishes and privacy of the deceased individual.

Family members 1730, for example, may have access to a broad range of personal content, including private family photos, videos, and intimate communications that were shared only within the family group. The role-based permission processor 1513 ensures that only those who are classified as family members, according to the user-defined settings, are able to view or interact with this sensitive material. Similarly, family members might be given permission to upload additional content or leave messages on the digital cemetery plot, creating a space for ongoing remembrance and tribute.

Friends 1740, on the other hand, may be granted access to less private content, such as shared social media posts or photos from public events where the deceased was present. The permission settings could allow friends to view posts and memories that reflect the individual's social life, but not necessarily more personal, intimate content reserved for close family members. The role-based permission processor 1513 ensures that these boundaries are clearly defined, offering an additional layer of security and respect for the deceased individual's digital legacy.

Work colleagues 1750 typically have a more restricted set of permissions, with access granted to content related to the individual's professional life, such as work-related achievements, posts, or content from professional networking sites like LinkedIn. In some embodiments, the role-based permission processor 1513 could limit access to specific work-related materials, ensuring that colleagues only see content related to the deceased's career and professional relationships, rather than more personal or private memories. This level of customization allows the deceased individual to determine, prior to their passing, who can view what type of content and to what extent.

The role-based permission processor 1513 also provides flexibility, allowing users to adjust and update their permission settings dynamically. This ensures that as relationships and roles evolve over time-such as a friend becoming closer or a colleague transitioning into a more personal relationship-access controls can be modified accordingly. Additionally, the system may allow the user to define custom roles, granting access to other groups, such as acquaintances or extended family members, with permissions tailored to their specific relationship with the deceased. This dynamic set of permissions enhances the ability to respect individual privacy while fostering a meaningful and personalized digital memorial. The permission controls also ensure that the digital legacy remains accessible to those who need it, without compromising the integrity of the deceased's intended content distribution.

FIG. 18 expands upon the system 1510 from FIG. 15 by incorporating a geolocation processor 1812, which is responsible for storing and displaying one or more locations 1820 associated with the individual. In some embodiments, the geolocation processor 1812 integrates various types of location data, allowing for a comprehensive representation of the individual's associated places in life and after death. These locations 1820 may include interment locations 1822, such as burial sites or memorial spots where the individual's remains are laid to rest. The system allows for the precise marking and visualization of these interment locations, providing a virtual way to visit and reflect on the individual's final resting place, even from afar.

In addition to interment locations 1822, the geolocation processor 1812 may store and display the individual's residences 1824. These residences could be previous homes or places where the individual spent one or more portions of their life, offering insights into their personal history and the places that shaped their experiences. By displaying these residences 1824 on an interactive map or in conjunction with other relevant content, the system helps create a more holistic representation of the individual's life journey, accessible to family members, friends, and other designated users.

The geolocation processor 1812 can also track and display other relevant places 1826 using GPS coordinates. These places could include locations that held sentimental value to the deceased, such as favorite vacation spots, places of employment, or sites where important life events took place. By mapping these other relevant places 1826, the system provides a dynamic, location-based element to the digital cemetery plot, helping users connect with the individual's memory through geographically significant sites. For example, users may access a digital map that highlights the locations of a person's life milestones, with detailed descriptions or photos attached to each location, allowing for a more immersive and personalized remembrance experience.

This geolocation feature not only supports the preservation of memories tied to specific locations but also enables users to engage in a more interactive and reflective experience. For example, family members could virtually visit the deceased's childhood home or their favorite vacation destination through the system's map interface, creating a deeper connection to the individual's history. The GPS functionality can also provide directions to physical locations for those who wish to visit these places in real life, enhancing the system's utility for real-world memorialization. Additionally, these geolocation-based features could be customized, allowing the user to choose which locations are displayed, ensuring that only relevant or meaningful sites are included in the digital memorial.

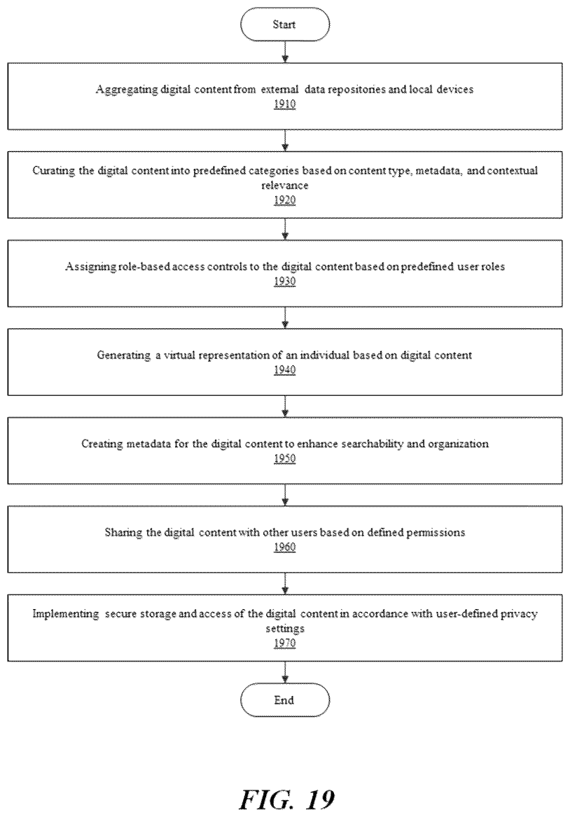

FIG. 19 outlines a method for managing digital content, which includes a series of steps configured to effectively organize, share, and protect digital content from multiple sources. In some embodiments, at block 1910, the method begins by aggregating digital content from various external data repositories and local devices. This step ensures that content from a variety of sources, such as social media platforms, cloud storage, and personal devices, is gathered into a central system. By pulling data from both external and internal repositories, the system ensures comprehensive access to a broad range of digital content, allowing users to manage and interact with all of their data from one unified platform.

At block 1920, the method proceeds to curate the aggregated digital content into predefined categories based on content type, metadata, and contextual relevance. This curation process helps organize the digital content into easily navigable sections, enhancing both usability and accessibility. For instance, content might be sorted into categories such as personal photos, work-related documents, social media posts, or communication logs. The contextual relevance of the content is also considered in the curation process, ensuring that related content is grouped together. This structured approach improves the user experience by making it easier to locate and interact with specific types of content, tailored to user preferences and needs.

At block 1930, the method assigns role-based access controls to the digital content. This step ensures that different types of users-such as family members, friends, colleagues, or service providers-can access the content according to their designated roles. Each role can have specific permissions that dictate which content they are allowed to view, edit, or share. For example, family members may have full access to personal content, while colleagues might only be permitted to view work-related documents. By implementing these role-based controls, the method ensures that the privacy and confidentiality of the individual's digital content are maintained according to the preferences and needs of both the content owner and the authorized users.

At block 1940, the method moves on to generate a virtual representation of the individual based on the collected digital content. This virtual avatar can be created using photos, videos, social media interactions, and other relevant digital data, offering a digital likeness of the individual that can be interacted with or memorialized in a digital space. This virtual representation can serve as a dynamic, evolving digital presence, reflecting the individual's personality, interests, and history in a way that can be shared with others.

At block 1950, the method includes creating metadata for the digital content to enhance searchability and organization. By generating descriptive, searchable metadata for each piece of content, the system improves the ability to find and retrieve specific items based on keywords, tags, or other attributes. This step makes the content more discoverable, both for the content owner and other authorized users, streamlining the process of locating specific memories or documents within the digital space.

At block 1960, the method allows for sharing the digital content with other users based on the permissions and conditions set earlier. This sharing process enables users to distribute content within their defined social circles or groups. For example, a family member may share a particular memory or photograph with others in the family group, while work-related content can be shared with colleagues. The defined permissions ensure that sensitive or personal content is shared only with appropriate parties, maintaining privacy and control over the content distribution.

Finally, at block 1970, the method implements secure storage and access for the digital content in accordance with user-defined privacy settings. This step ensures that the content is stored safely, using encryption or other security measures, and is only accessible to those with the proper permissions. The method incorporates security protocols to prevent unauthorized access, ensuring that the digital content is protected from potential breaches or misuse. By allowing users to define their own privacy settings, the method provides a customizable approach to digital content management, giving individuals complete control over who can access their data and how it is shared.

### EXAMPLES

In some aspects, the techniques described herein relate to a social media cemetery for retaining social media content post-humous including: a resting place platform including at least a computing device having a processor and a memory storing a set of computer readable instructions, which when executed by the processor cause the computing device to: establish a digital cemetery plot for a deceased person, who when living was an account holder of a plurality of social media accounts, each provided by a different social media platform, wherein the digital cemetery plot is provided by the resting place platform, which indexes content of the social media accounts in accordance with a plurality of different group categories, each having a group-defined relationship with the deceased person, wherein a first portion of content from the social media accounts is associated with a first group, wherein a second portion of content from the social media accounts is associated with a second group, wherein the first portion and the second portion each include content from more than one of the social media accounts; responsive to an access request directed to the digital cemetery plot from a first of the different computing devices, determine a first user requesting access is a member of the first group and providing access to the first portion of content; and responsive to a second access request directed to the digital cemetery plot from a second of the different computing devices, determine a second user requesting access is a member of the second group and providing access to the second portion of content.

In some aspects, the techniques described herein relate to a social media cemetery, wherein the first group is immediate family of the deceased person, wherein the second group is an extended family member of the deceased person.

In some aspects, the techniques described herein relate to a social media cemetery, wherein the first group is family of the deceased person, wherein the second group is work-related peers of the deceased person.

In some aspects, the techniques described herein relate to a social media cemetery, wherein members of the first group had access to the first portion of content via the social media accounts when the deceased person was alive, and wherein members of the second group had access to the second portion of content via the social media accounts when the deceased person was alive.

In some aspects, the techniques described herein relate to a social media cemetery, wherein at least a subset of the social media accounts are disabled upon death of the deceased person so that access to content contained therein is inaccessible to the first group and to the second group absent the resting place platform.

In some aspects, the techniques described herein relate to a social media cemetery, wherein execution of the computer readable instructions by the processor further causes the computing device to: collect content of one of the social media accounts and store the collected content within a resting place repository; and once content of the one social media account is stored in the resting place repository, delete the one of the social media account.

In some aspects, the techniques described herein relate to a social media cemetery, wherein the digital cemetery plot presents the first and second user with an selection of different social media account types, wherein a subset of the first and second portion are presented responsive to selection of a first of the different social media account types for a specific one of the social media accounts, wherein a second subset of the first and second portions are presented responsive to selection of a second of the different social media account types for a second specific one of the social media accounts.

In some aspects, the techniques described herein relate to a social media cemetery, wherein the social media accounts include a FACEBOOK account, an INSTAGRAM account, and a LINKED IN account.

In some aspects, the techniques described herein relate to a social media cemetery, wherein the digital cemetery plot is a part of a family digital cemetery plot including a plurality of different digital plots for different family members, each of the different digital plots being established by the resting place platform.

In some aspects, the techniques described herein relate to a social media cemetery, wherein execution of the computer readable instructions by the processor further causes the computing device to: remove all content from each of the social media accounts that is not to be presented to at least one of the different group categories via the resting place platform, whereby potentially negative content representing the removed content from the social media accounts is no longer accessible after a death of the deceased person.

In some aspects, the techniques described herein relate to a social media cemetery, wherein execution of the computer readable instructions by the processor further causes the computing device to: grant administrative control over the digital cemetery plot to an executor approved by the deceased person prior to death.

In some aspects, the techniques described herein relate to a social media cemetery, wherein the executor determines what content of the social media accounts is potentially negative content prior to that content being removed.

In some aspects, the techniques described herein relate to a social media cemetery, wherein the cemetery plot is subset of at least one family cemetery plot and is also a subset of at least one work-group cemetery plot, wherein the family cemetery plot and the work-group cemetery plot are established by the resting place platform.

In some aspects, the techniques described herein relate to a social media cemetery, wherein the computing device of the resting place platform include a resting place server application, said resting place server application including: a social media transition service component configured to change a state of the social media accounts to reflect death and to curate content from the social media accounts for storage within a resting place repository, which is part of the resting place platform.

In some aspects, the techniques described herein relate to a social media cemetery, wherein the computing device of the resting place platform include a resting place server application, said resting place server application including: a resting place communications component configured to permit communications related to the deceased person between members of the first group and to permit communications related to the deceased person between members of the second group; and one or more artificial intelligence (AI) based simulations for an interaction with an avatar based on a persona of the deceased person.

In some aspects, the techniques described herein relate to a method for retaining social media content post-humous including: establishing a digital cemetery plot for a deceased individual, who when living was an account holder of a plurality of social media accounts, each provided by a different social media platform, wherein the digital cemetery plot is provided by a resting place platform, which indexes content of the social media accounts in accordance with a plurality of different group categories, each having a group-defined relationship with the deceased individual, wherein a first portion of content from the social media accounts is associated with a first group, wherein a second portion of content from the social media accounts is associated with a second group, wherein the first portion and the second portion each include content from more than one of the social media accounts; responsive to an access request directed to the digital cemetery plot from a first computing device, determining a first user requesting access is a member of the first group and providing access to the first portion of content; responsive to a second access request directed to the digital cemetery plot from a second computing device, determining a second user requesting access is a member of the second group and providing access to the second portion of content; simulating an interaction with an avatar based on a persona of a deceased person, including: obtaining data associated with the deceased person, the data including one or more of textual data, audio data, video data, or social media data; analyzing the obtained data to generate a persona model representative of at least one of a characteristic, a communication style, and a personality trait of the deceased person; generating the avatar based on the persona model, wherein the avatar visually resembles the deceased person and simulates verbal and non-verbal behaviors consistent with the persona model; enabling user interaction with the avatar through natural language processing, wherein the avatar responds to user inputs using simulated responses derived from the persona model; and dynamically updating the avatar's responses based on contextual inputs during the interaction to provide a personalized and contextually appropriate experience.

In some aspects, the techniques described herein relate to a method, wherein at least a subset of the social media accounts is disabled upon death of the deceased person so that access to content contained therein is inaccessible to the first group and to the second group absent the resting place platform.

In some aspects, the techniques described herein relate to a method, further including: collecting content of one of the social media accounts and store the collected content within a resting place repository; and once content of the one social media account is stored in the resting place repository, deleting the one social media account.

In some aspects, the techniques described herein relate to a method for retaining social media content post-humous including: establishing a digital cemetery plot for a deceased person, who when living was an account holder of a plurality of social media accounts, each provided by a different social media platform, wherein the digital cemetery plot is provided by a resting place platform, which indexes content of the social media accounts in accordance with a plurality of different group categories, each having a group-defined relationship with the deceased person, wherein a family portion of content from the social media accounts is associated with a family group, wherein a work portion of content from the social media accounts is associated with a work group, wherein the family portion and the work portion each include content from more than one of the social media accounts; responsive to an access request directed to the digital cemetery plot from a first computing device, determining a first user requesting access is a member of the family group and providing access to the family portion of content; and responsive to a second access request directed to the digital cemetery plot from a second computing device, determining a second user requesting access is a member of the work group and providing access to the work portion of content.

In some aspects, the techniques described herein relate to a method, wherein at least a subset of the social media accounts is disabled upon death of the deceased person so that access to content contained therein is inaccessible to the family group and to the work group absent the resting place platform.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable instructions are provided to the processor 334 of a general purpose computer, special purpose computer, or other programmable data processing apparatus (e.g., the computing device 336) to produce a machine, such that the instructions, which execute via the processor 334 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 336), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A social media cemetery for retaining social media content post-humous comprising:
a resting place platform comprising at least a computing device having a processor and a memory storing a set of computer readable instructions, which when executed by the processor cause the computing device to:
establish a digital cemetery plot for a deceased person, who when living was an account holder of a plurality of social media accounts, each provided by a different social media platform, wherein the digital cemetery plot is provided by the resting place platform, which indexes content of the social media accounts in accordance with a plurality of different group categories, each having a group-defined relationship with the deceased person, wherein a first portion of content from the social media accounts is associated with a first group, wherein a second portion of content from the social media accounts is associated with a second group, wherein the first portion and the second portion each comprise content from more than one of the social media accounts;
responsive to an access request directed to the digital cemetery plot from a first of the different computing devices, determine a first user requesting access is a member of the first group and providing access to the first portion of content; and
responsive to a second access request directed to the digital cemetery plot from a second of the different computing devices, determine a second user requesting access is a member of the second group and providing access to the second portion of content.

2. The social media cemetery of claim 1, wherein the first group is immediate family of the deceased person, wherein the second group is an extended family member of the deceased person.

3. The social media cemetery of claim 1, wherein the first group is family of the deceased person, wherein the second group is work-related peers of the deceased person.

4. The social media cemetery of claim 1, wherein members of the first group had access to the first portion of content via the social media accounts when the deceased person was alive, and wherein members of the second group had access to the second portion of content via the social media accounts when the deceased person was alive.

5. The social media cemetery of claim 1, wherein at least a subset of the social media accounts are disabled upon death of the deceased person so that access to content contained therein is inaccessible to the first group and to the second group absent the resting place platform.

6. The social media cemetery of claim 1, wherein execution of the computer readable instructions by the processor further causes the computing device to:
collect content of one of the social media accounts and store the collected content within a resting place repository; and
once content of the one social media account is stored in the resting place repository, delete the one of the social media account.

7. The social media cemetery of claim 1, wherein the digital cemetery plot presents the first and second user with an selection of different social media account types, wherein a subset of the first and second portion are presented responsive to selection of a first of the different social media account types for a specific one of the social media accounts, wherein a second subset of the first and second portions are presented responsive to selection of a second of the different social media account types for a second specific one of the social media accounts.

8. The social media cemetery of claim 1, wherein the social media accounts comprise a FACEBOOK account, an INSTAGRAM account, and a LINKED IN account.

9. The social media cemetery of claim 1, wherein the digital cemetery plot is a part of a family digital cemetery plot comprising a plurality of different digital plots for different family members, each of the different digital plots being established by the resting place platform.

10. The social media cemetery of claim 1, wherein execution of the computer readable instructions by the processor further causes the computing device to:
remove all content from each of the social media accounts that is not to be presented to at least one of the different group categories via the resting place platform, whereby potentially negative content representing the removed content from the social media accounts is no longer accessible after a death of the deceased person.

11. The social media cemetery of claim 1, wherein execution of the computer readable instructions by the processor further causes the computing device to:
grant administrative control over the digital cemetery plot to an executor approved by the deceased person prior to death.

12. The social media cemetery of claim 11, wherein the executor determines what content of the social media accounts is potentially negative content prior to that content being removed.

13. The social media cemetery of claim 1, wherein the cemetery plot is subset of at least one family cemetery plot and is also a subset of at least one work-group cemetery plot, wherein the family cemetery plot and the work-group cemetery plot are established by the resting place platform.

14. The social media cemetery of claim 1, wherein the computing device of the resting place platform comprise a resting place server application, said resting place server application comprising:
a social media transition service component configured to change a state of the social media accounts to reflect death and to curate content from the social media accounts for storage within a resting place repository, which is part of the resting place platform.

15. The social media cemetery of claim 1, wherein the computing device of the resting place platform comprise a resting place server application, said resting place server application comprising:
a resting place communications component configured to permit communications related to the deceased person between members of the first group and to permit communications related to the deceased person between members of the second group; and
one or more artificial intelligence (AI) based simulations for an interaction with an avatar based on a persona of the deceased person.

16. A method for retaining social media content post-humous comprising:
establishing a digital cemetery plot for a deceased individual, who when living was an account holder of a plurality of social media accounts, each provided by a different social media platform, wherein the digital cemetery plot is provided by a resting place platform, which indexes content of the social media accounts in accordance with a plurality of different group categories, each having a group-defined relationship with the deceased individual, wherein a first portion of content from the social media accounts is associated with a first group, wherein a second portion of content from the social media accounts is associated with a second group, wherein the first portion and the second portion each comprise content from more than one of the social media accounts;
responsive to an access request directed to the digital cemetery plot from a first computing device, determining a first user requesting access is a member of the first group and providing access to the first portion of content;
responsive to a second access request directed to the digital cemetery plot from a second computing device, determining a second user requesting access is a member of the second group and providing access to the second portion of content;
simulating an interaction with an avatar based on a persona of a deceased person, comprising:
obtaining data associated with the deceased person, the data including one or more of textual data, audio data, video data, or social media data;
analyzing the obtained data to generate a persona model representative of at least one of a characteristic, a communication style, and a personality trait of the deceased person;
generating the avatar based on the persona model, wherein the avatar visually resembles the deceased person and simulates verbal and non-verbal behaviors consistent with the persona model;
enabling user interaction with the avatar through natural language processing, wherein the avatar responds to user inputs using simulated responses derived from the persona model; and
dynamically updating the avatar's responses based on contextual inputs during the interaction to provide a personalized and contextually appropriate experience.

17. The method of claim 16, wherein at least a subset of the social media accounts is disabled upon death of the deceased person so that access to content contained therein is inaccessible to the first group and to the second group absent the resting place platform.

18. The method of claim 16, further comprising:
collecting content of one of the social media accounts and store the collected content within a resting place repository; and
once content of the one social media account is stored in the resting place repository, deleting the one social media account.

19. A method for retaining social media content post-humous comprising:
establishing a digital cemetery plot for a deceased person, who when living was an account holder of a plurality of social media accounts, each provided by a different social media platform, wherein the digital cemetery plot is provided by a resting place platform, which indexes content of the social media accounts in accordance with a plurality of different group categories, each having a group-defined relationship with the deceased person, wherein a family portion of content from the social media accounts is associated with a family group, wherein a work portion of content from the social media accounts is associated with a work group, wherein the family portion and the work portion each comprise content from more than one of the social media accounts;
responsive to an access request directed to the digital cemetery plot from a first computing device, determining a first user requesting access is a member of the family group and providing access to the family portion of content; and
responsive to a second access request directed to the digital cemetery plot from a second computing device, determining a second user requesting access is a member of the work group and providing access to the work portion of content.

20. The method of claim 19, wherein at least a subset of the social media accounts is disabled upon death of the deceased person so that access to content contained therein is inaccessible to the family group and to the work group absent the resting place platform.
